(19) United States
(12) Patent Application Publication
(10) Pub. No.: US 2025/0293453 A1
(43) Pub. Date: Sep. 18, 2025

(54) LOCKOUT DEVICES AND METHODS OF USE

(71) Applicant: Affordable Wire Management, LLC, Bedminster, NJ (US)

(72) Inventors: Scott Robert Rand, Bedminster, NJ (US); Daniel Robert Smith, Bedminster, NJ (US); Peter Mark Hruby, Bedminster, NJ (US)

(21) Appl. No.: 18/860,457

(22) PCT Filed: Apr. 25, 2023
(86) PCT No.: PCT/US23/66186

§ 371 Date: Oct. 25, 2024

Related U.S. Application Data
(60) Provisional application No. 63/363,547, filed on Apr. 25, 2022.

(51) Int. Cl. H01R 13/443

(52) U.S. Cl. CPC H01R 13/443

(57) ABSTRACT

The devices described herein include a body extending between a proximal end and a distal end, and having an interior volume therein. A first projection extends from the body at the distal end, and includes a first through-bore, where the first projection forms a first channel with the body. A first ledge is positioned within the first channel and on the first projection, the first ledge extending towards the body. A second projection extends from the body at the distal end, opposite the first projection, and includes a second through-bore, where the second projection forms a second channel with the body. A second ledge is positioned within the second channel and on the second projection, the second ledge extending towards the body.

### CROSS-REFERENCE TO RELATED APPLICATIONS

The present application claims priority under 35 U.S.C. § 119(e) to U.S. Provisional Patent Application No. 63/363,547, entitled “SOLAR CONNECTOR SELF-LOCKING DUST CAP LOCKOUT DEVICE,” filed on Apr. 25, 2022, the entire contents of which is hereby expressly incorporated by reference herein.

### FIELD

The present application generally relates to lockout systems, and more specifically, to utility-scale solar power generation self-locking dust cap lockout systems.

### BACKGROUND

Energy production and transmission infrastructures utilize a number of cable types to convey electrical current, and/or signal data from source facilities to consumer locations. In large-scale solar power plants, cables can convey electrical current and signal data from solar panels to other production and/or transmission equipment within the plant. The cables can be arranged in underground or above-ground configurations. These cables can include connectors arranged on either end of the cable for connecting to adjacent cables or power generation or distribution systems, such as a solar panel.

During commissioning, which is a process of assuring that all systems and components of an energy production facility are designed, installed, tested, operated, and maintained according to set operational requirements, the order of energizing different system can be crucial to the safety of the persons on-site. Additionally, it is important for the connection points of cables and energy systems to have limited dust and sand exposure to ensure a reliable electrical connection between the connection points. Additionally, the connection points of cables can accidentally be left in locations where mud or puddles of water can form, exposing the connector to water, moisture, and other foreign objects. Additionally, due to construction schedules and supply chains, the connection points of the cables may be installed weeks or months before they are connected into their final positions, this leaves them exposed to the outdoor elements such as rain or dust. Traditionally, flexible bags are used to cover connectors of cables and energy systems in order to prevent connection between systems. However, these flexible bags can be easily removed or fall off, and, due to being exposed to the elements, can collect water and allow dust into the connector and cause corrosion issues to the connector, which can lead to future electrical risks.

### SUMMARY

Lockout devices and methods of use are provided.

In an aspect, a device is provided. The device can include a body extending between a proximal end and a distal end, and having an interior volume therein. A first projection extends from the body at the distal end, and includes a first through-bore, where the first projection forms a first channel with the body. A first ledge is positioned within the first channel and on the first projection, the first ledge extending towards the body. A second projection extends from the body at the distal end, opposite the first projection, and includes a second through-bore, where the second projection forms a second channel with the body. A second ledge is positioned within the second channel and on the second projection, the second ledge extending towards the body.

The device can have a variety of configurations. For example, in some aspects, the body can include a third projection extending from the body and positioned vertically above the first channel. In other aspects, the body can include a fourth projection extending from the body, opposite the third projection, and positioned vertically above the second channel. In certain aspects, a first gap can be positioned between the first projection and the third projection. In some aspects, a second gap can be positioned between the second projection and the fourth projection. In some aspects, the device can further include a first tab extending from the distal end of the body, and a second tab extending from the distal end of the body, opposite the first tab. In some aspects, the first ledge and the second ledge can be configured to abut against corresponding features of a connector arranged within the first channel and the second channel. In some aspects, the interior volume can be configured to receive a portion of a connector. In some aspects, a third through-bore can be positioned radially outward of the first through-bore. In some aspects, a fourth through-bore can be positioned radially outward of the second through-bore. In other aspects, the body can include a sealing surface configured to abut a portion of a connector to form a seal between the body and the connector.

In another aspect, a device is provided that can include a support body extending between a first end and a second end. A round body extends from the support body. A first locking tab is positioned on the first end of the support body, extending from the support body, and including a first ledge. A first through-bore is positioned in the support body and vertically above the first ledge. A second locking tab is positioned on the second end of the support body, opposite the hollow body, extending from the support body, and including a second ledge. A second through-bore is positioned in the support body and vertically above the second ledge. A first tab extends from the body at the first end, radially outward of the first locking tab. A second tab extends from the body at the second end, radially outward of the second locking tab.

The device can have a variety of configurations. For example, in some aspects, the first locking tab and the second locking tab can be deformable relative to the support body. In some aspects, the first locking tab and the second locking tab can be configured to extend into a plurality of channels of a connector. In certain aspects, the first ledge and the second ledge can be configured to abut against corresponding features within the plurality of channels. In some aspects, the round body can be configured to seal a port of the connector with the first and second ledge abutting the corresponding features. In some aspects, the first tab can extend from the support body a length greater than the first locking tab. In some aspects, the second tab can extend from the support body a length greater than the second locking tab. In certain aspects, a third through-bore can be positioned radially outward of the first through-bore. In certain aspects, a fourth through-bore can be positioned radially outward of the second through-bore. In other aspects, the support body can include a sealing surface configured to abut a portion of a connector to form a seal between the body and the connector.

In another aspect, a device is provided that includes a first portion and a second portion. The first portion can include a body extending between a proximal end and a distal end, and having an interior volume therein. A first projection extends from the body at the distal end, and includes a first through-bore, where the first projection forms a first channel with the body. A first ledge is positioned within the first channel and on the first projection, the first ledge extending towards the body. A second projection extends from the body at the distal end, opposite the first projection, and includes a second through-bore, where the second projection forms a second channel with the body. A second ledge is positioned within the second channel and on the second projection, the second ledge extending towards the body. The second portion can include a support body connected to the body, and extending between a first end and a second end. A round body extends from the support body. A first locking tab is positioned on the first end of the support body, extending from the support body, and including a first ledge. A second locking tab is positioned on the second end of the support body, opposite the hollow body, extending from the support body, and including a second ledge.

In one aspect, the support body can be arranged at the proximal end of the body. In another aspect, the support body can include a sealing surface arranged on an opposite side of the support body than the body.

### BRIEF DESCRIPTION OF THE DRAWINGS

These and other features will be more readily understood from the following detailed description taken in conjunction with the accompanying drawings, in which:

FIG. 1 is a top perspective view of one aspect of a lockout device;

FIG. 2 is a bottom perspective view of the lockout device of FIG. 1;

FIG. 3 is a front view of the lockout device of FIG. 1;

FIG. 4 is a bottom view of the lockout device of FIG. 1;

FIG. 5 is a side view of the lockout device of FIG. 1;

FIG. 6 is a cross-sectional view of the lockout device of FIG. 1 taken along line 6-6 in FIG. 5;

FIG. 7 is a perspective view of the lockout device of FIG. 1 installed on a solar connector with Female-type connector pins;

FIG. 7A is a side view of the lockout device installed on the solar connector of FIG. 7;

FIG. 8 is a cross-sectional view of the lockout device and solar connector of FIG. 7 taken along line 8-8 in FIG. 7A;

FIG. 9 is a top perspective view of another aspect of a lockout device;

FIG. 10 is a bottom perspective view of the lockout device of FIG. 9;

FIG. 11 is a front view of the lockout device of FIG. 9;

FIG. 12 is a bottom view of the lockout device of FIG. 9;

FIG. 13 is a side view of the lockout device of FIG. 9;

FIG. 14 is a cross-sectional view of the lockout device of FIG. 9 taken along line 14-14 in FIG. 13;

FIG. 15 is a perspective view of the lockout device of FIG. 9 installed on a solar connector with Male-type connector pins;

FIG. 16 is a side view of the lockout device installed on the solar connector of FIG. 15;

FIG. 17 is a cross-sectional view of the lockout device and solar connector of FIG. 15 taken along line 17-17 in FIG. 16;

FIG. 18 is a front view of a removal tool;

FIG. 19 is a perspective view of the lockout device of FIG. 1 installed on a connector with Female-type connector pins;

FIG. 20 is a perspective view of the lockout device of FIG. 9 installed on a connector with Male-type connector pins;

FIG. 21 is a perspective view of an aspect of a self-locking dust cap lockout device for a solar connector including a self-locking dust cap lockout device for a solar connector in a flat position;

FIG. 22 is a side view of the self-locking dust cap lockout device for a solar connector of FIG. 21;

FIG. 23 is a top view of the self-locking dust cap lockout device for a solar connector of FIG. 21;

FIG. 24 is a perspective view of the self-locking dust cap lockout device for a solar connector of FIG. 21 installed on a solar connector with Female-type connector pins;

FIG. 25 is a perspective view of another aspect of a self-locking dust cap lockout device with a cap-type round body to couple with the solar connector;

FIG. 26 is a perspective view of the self-locking dust cap lockout device of FIG. 25 installed on a solar connector with Female-type connector pins and engaged with the locking features of the connector;

FIG. 27 is a perspective view of the self-locking dust cap lockout device of FIG. 25 installed on a solar connector with Male-type connector pins and engaged with the locking features of the connector;

FIG. 28 is a perspective view of another aspect of a self-locking dust cap lockout device with a different-sized cap-type round body to couple with the male solar connector;

FIG. 29 is a perspective view of the self-locking dust cap lockout device of FIG. 28 installed on a solar connector with Male-type connector pins and engaged with the locking features of the connector;

FIG. 30 is a perspective view of another aspect of a self-locking dust cap lockout device for a solar connector;

FIG. 31 is a side view of the lockout device of FIG. 30;

FIG. 32 is a tip view of the lockout device of FIG. 30;

FIG. 33 is a perspective view of the self-locking dust cap lockout device of FIG. 30 installed on a solar connector with Female-type connector pins and engaged with the locking features of the connector;

FIG. 34 is a top view of the lockout device installed on the connector of FIG. 33;

FIG. 35 is a perspective view of another aspect of a self-locking dust cap lockout device for a solar connector;

FIG. 36 is a side view of the lockout device of FIG. 35;

FIG. 37 is a tip view of the lockout device of FIG. 35;

FIG. 38 is a perspective view of the self-locking dust cap lockout device of FIG. 35 installed on a solar connector with Male-type connector pins and engaged with the locking features of the connector;

FIG. 39 is a top view of the lockout device installed on the connector of FIG. 38;

FIG. 40 is a perspective view of another aspect of a self-locking dust cap lockout device for a solar connector;

FIG. 41 is a side view of the lockout device of FIG. 40;

FIG. 42 is a tip view of the lockout device of FIG. 40;

FIG. 43 is a perspective view of the self-locking dust cap lockout device of FIG. 14 installed on a solar connector with Female-type connector pins and engaged with the locking features of the connector;

FIG. 44 is perspective view of another aspect of the self-locking dust cap lockout device for a solar connector;

FIG. 45 is a perspective view of the standard self-locking dust cap lockout device for a solar connector of FIG. 44 installed on a solar connector with Female-type connector pins;

FIG. 46 is perspective view of another aspect of the self-locking dust cap lockout device for a solar connector position in a flat position;

FIG. 47 is a perspective view of the self-locking dust cap lockout device for a solar connector of FIG. 46 installed on a solar connector with Male-type connector pins;

FIG. 48 is perspective view of another aspect of a the self-locking dust cap lockout device for a solar connector position in a flat position;

FIG. 49 is a perspective view of the standard self-locking dust cap lockout device for a solar connector of FIG. 48 installed on a solar connector with Female-type connector pins;

FIG. 50 is perspective view of another aspect of a the self-locking dust cap lockout device e for a solar connector position in a flat position;

FIG. 51 is a perspective view of the standard self-locking dust cap lockout device for a solar connector of FIG. 50 installed on a solar connector with Female-type connector pins; and

FIG. 52 is a perspective view of another aspect of the self-locking dust cap lockout device for a solar connector.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary aspects will now be described to provide an overall understanding of the principles of the structure, function, manufacture, and use of the devices and methods disclosed herein. One or more examples of these aspects are illustrated in the accompanying drawings. Those skilled in the art will understand that the devices and methods specifically described herein and illustrated in the accompanying drawings are non-limiting exemplary aspects and that the scope of the present invention is defined solely by the claims. The features illustrated or described in connection with one exemplary aspect may be combined with the features of other aspects. Such modifications and variations are intended to be included within the scope of the present invention.

Energy production and transmission infrastructures utilize a number of cable types to convey electrical current, signal data, and grounding paths from source facilities to consumer locations. In large-scale solar power plants, cables can convey electrical current, signal data, and ground paths from solar panels to other production and/or transmission equipment within the plant. Additionally, conventional solar panels are often attached to a single-axis solar tracker, which rotates the solar panel from East to West throughout the day such that the solar panels follow the sun, maximizing their energy output. The cables to those solar panels can be arranged in underground or aboveground configurations.

Energy production and transmission infrastructures utilize a number of cable connections to convey electrical current from source facilities to consumer locations. In large-scale solar power plants, cables and connectors can convey electrical current from solar panels to other harness cables and/or transmission equipment within the plant. The cables are arranged aboveground, near the solar panels, typically in a location that is easily accessible to humans.

The aboveground cable configurations, such as those used in utility-scale solar power generation and transmission systems, can be deployed using hand-made electrical connections with “plug-and-play” connectors such that the electrical connection can be made by easily coupling the male and female connectors to one another by hand. These connections must be energized and connected in a specific sequence to avoid an electrical shock and include additional safety risks. In order to prevent such a scenario, a lockout device can be used prevent the connectors from becoming electrically coupled together until the lockout device is removed with a tool. In addition, to help prevent electrical safety risk, the lockout device can have features such that a safety tag can be coupled to the lockout device, this would alert unaware installers to not attempt to electrically couple the connectors.

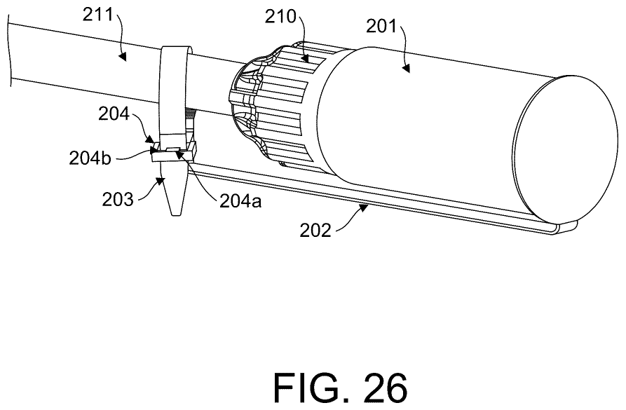

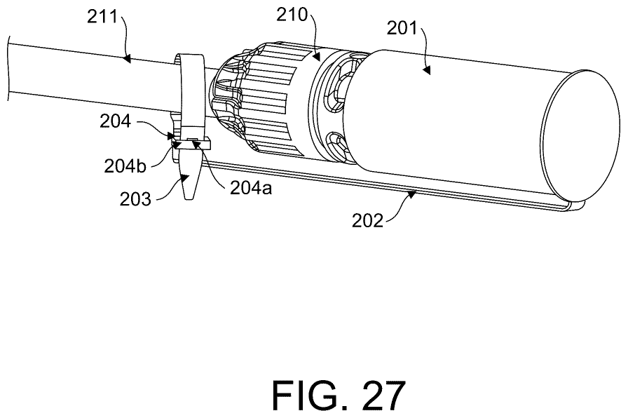

The solar connector self-locking dust cap lockout devices disclosed herein are commonly a single component with a dust-ingress prevention feature (plug or cap), a lockout feature that prevents the connector to be electrically coupled to another connector, a self-locking feature that requires a tool to be used to unlocked and remove the device, and a tag-attachment feature to allow a safety tag to be coupled to the device. In some aspects, the tag-attachment feature can act as a tampering indicator feature by breaking off if an installer tries to remove the tag or lockout device forcefully or incorrectly. In some aspects, large-scale solar plants deploy plastic bags, mesh bags, balloons, or other non-intended lockout devices, as depicted in FIG. 26, can require a separate device to couple the bag on the connector such as a cable tie or tape. In addition, large-scale solar plants deploy a separate dust prevention device, as depicted in FIG. 27. It is advantageous to use a proper lockout device for the solar connectors, that complies with OSHA requirements and requires a tool to be removed. It is also advantageous to combine the lockout device with the device used to couple the lockout device to the solar connector, this can be described as “self-locking”. It is also advantageous to combine the self-locking lockout member and dust prevention member in order to increase the installation efficiency of the lockout and dust prevention devices. In addition, a single component can be advantageous over the current method of using separate components due to less material use, which can be a more cost-effective solution compared to separate components.

Embodiments of a self-locking dust cap lockout device described herein combine a self-locking lockout member and dust prevention member into a singular component. This is advantageous to the cable assembly companies as well as the solar construction and installation companies since the singular component is less material and cost than three separate components. The singular-component aspect of the self-locking dust cap lockout device will result in less material and components on the solar power plant or solar cable assembly factory than traditional lockout and dust prevention devices, which is easier to manage and keep track of during the assembly phase of the solar cable and the construction phase of a solar power plant. This results in the cable assembler and solar construction and installation companies saving time and money by increasing efficiency.

An additional benefit is that the singular-component aspect of the self-locking dust cap lockout device will result in fewer shipping boxes than using various components, which is easier to manage and keep track of during the solar cable assembly phase and construction phase of a solar power plant, which saves the cable assembler and solar construction and installation companies time and money. Also, the singular-component aspect of the device results in less parts for a factory worker or installer to carry around a solar cable assembly factory or large-scale solar plant, thus increasing the worker's or installer's productivity as there is less weight to carry and less parts to manage. By being made of a single component, the self-locking dust cap lockout device disclosed herein results in fewer lost parts as small components, such as the dust prevention device, can easily be dropped and lost in dirt, tall grass, or snow typically found on large-scale solar power plants. In addition, the singular-component aspect of the self-locking dust cap lockout device results in fewer components that need to be assembled or installed which is faster for the assembler or installer than using various components, which saves the solar cable assembly and solar construction and installation companies time and money. Additionally, the singular-component aspect of the self-locking dust cap lockout device results in fewer components that need to be inspected for quality, which saves the cable assembly and solar construction and installation companies time and money.

Solar lockout devices and dust prevention devices disclosed herein are configured to be coupled with any solar connector and wire assembly. On large-scale solar plants, this can result in tens of thousands of lockout devices and dust prevention devices needing to be installed, so solar construction and installation companies are constantly developing methods to reduce the time it takes to install lockout and solar prevention devices found on large-scale solar power plants. The benefits of the self-locking dust cap lockout device described above reduce the time it takes to install lockout and dust prevention devices found on large-scale solar power plants.

Solar Connector self-locking dust cap lockout devices can have various implementations, which are used to lockout and prevent dust from entering the solar connector. Implementations of a self-locking dust cap lockout device disclosed herein can include a round body that could either be a solid body to act as a plug or a hollow body to act as a cap, a thin and flexible extension member, a thin and flexible end tail with rib ratcheting features, and a ratchet locking feature to lock the end tail in place at various locations. In addition, some implementations of the self-locking dust cap lockout device have a support body to be coupled with the cable of the connector. The end tail cannot be removed from the ratchet locking featuring without destroying the ratchet locking feature with a tool. In addition, the round body cannot feature cannot be removed from the solar connector until the extension member or end tail has been cut down with a tool. In other implementations of a self-locking dust cap lockout device disclosed herein can include round body to act as a plug, a support body with large through-bore holes to couple and lock together with the solar connector's locking feature, and side tabs with small through-bore holes for coupling a safety tag to the device. The device cannot be removed without engaging the solar connector's locking features with a specialized custom tool or disconnect tool for solar connectors. If an untrained installer tries to remove the safety tag forcefully and incorrectly, the side tabs can break off, providing a visual indication of tampering. All implementations of a self-locking dust cap lockout device disclosed herein can be designed for various solar electrical connectors, such as MC4, H4, SOLARLOK, TE Connectivity.

All implementations of a self-locking dust cap lockout device disclosed herein can be made of non-electrically conductive material, such as thermoplastic materials or any non-electrically conductive material. The material by which the self-locking dust cap lockout device is made from should be insulating and prevent energization, which can make the self-locking dust cap lockout device touch safe during energization. All implementations of a self-locking dust cap lockout device disclosed herein can be made from material that meets industry standard UL rated flammability requirements. The self-locking dust cap lockout device can be made in any color but is typically made in bright safety colors for better conformance. For example, the solar lockout system can be colored a bright safety red.

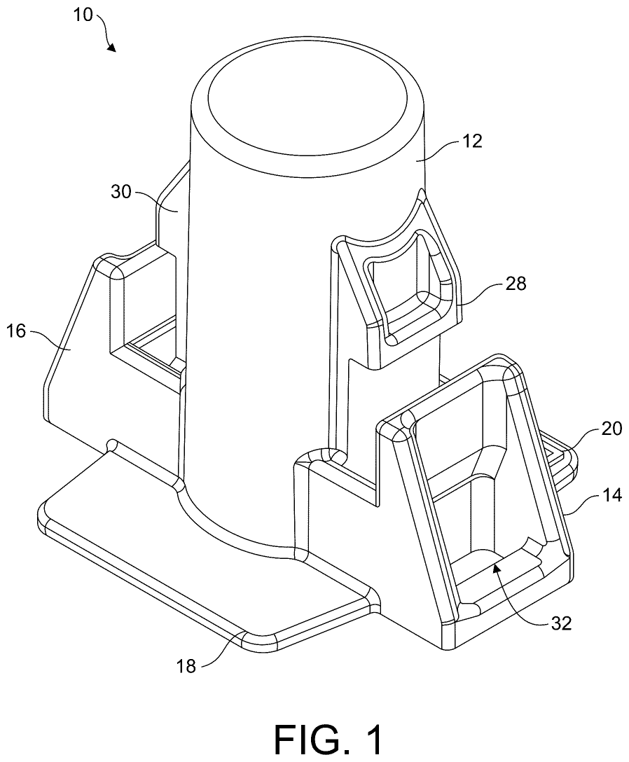

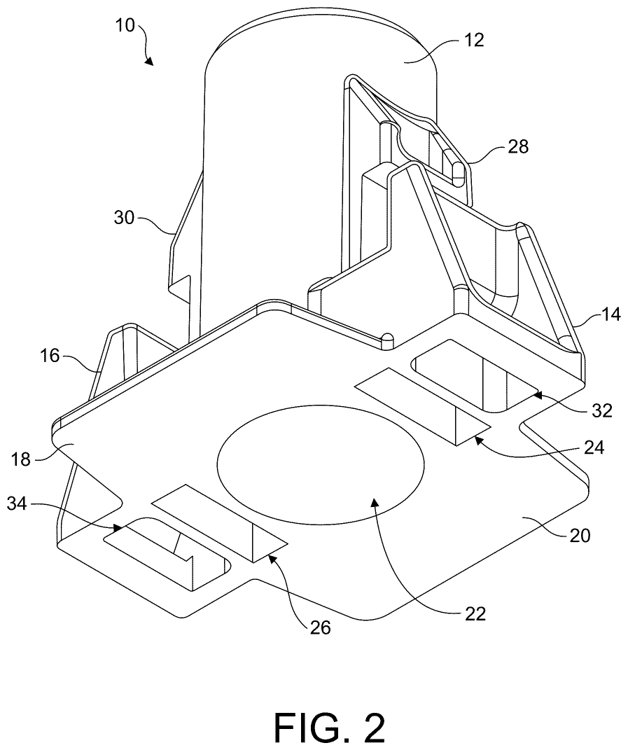

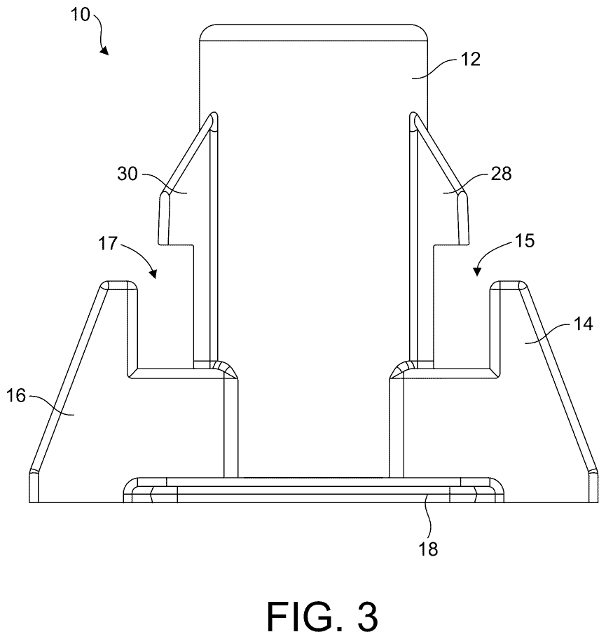

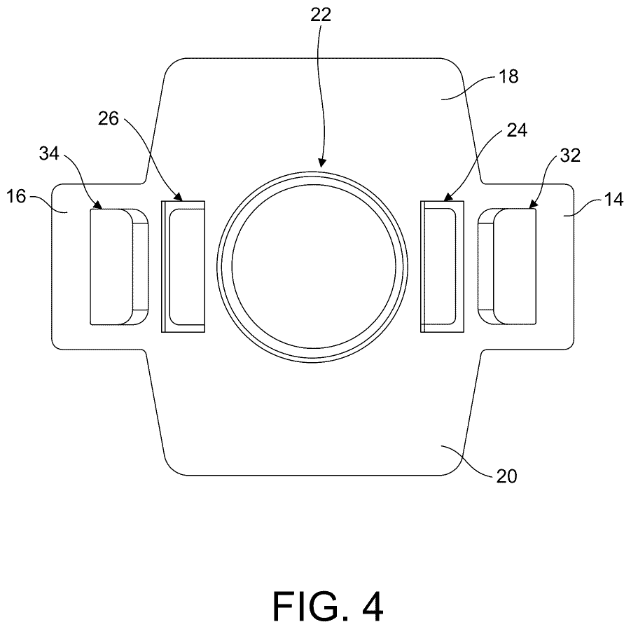

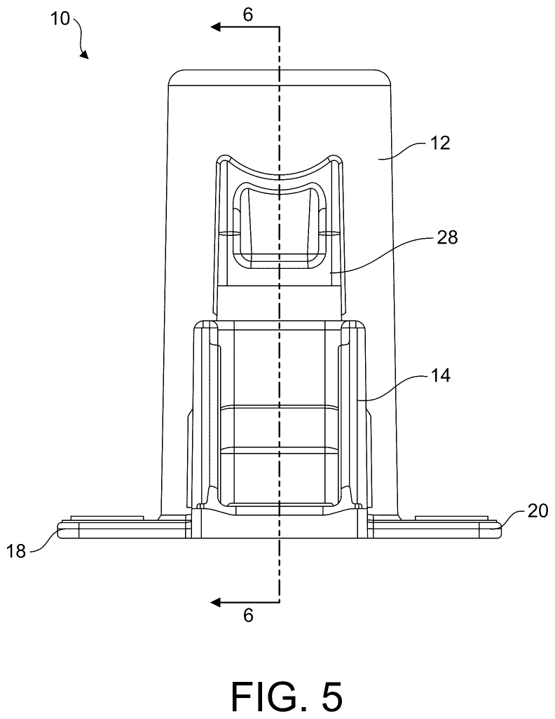

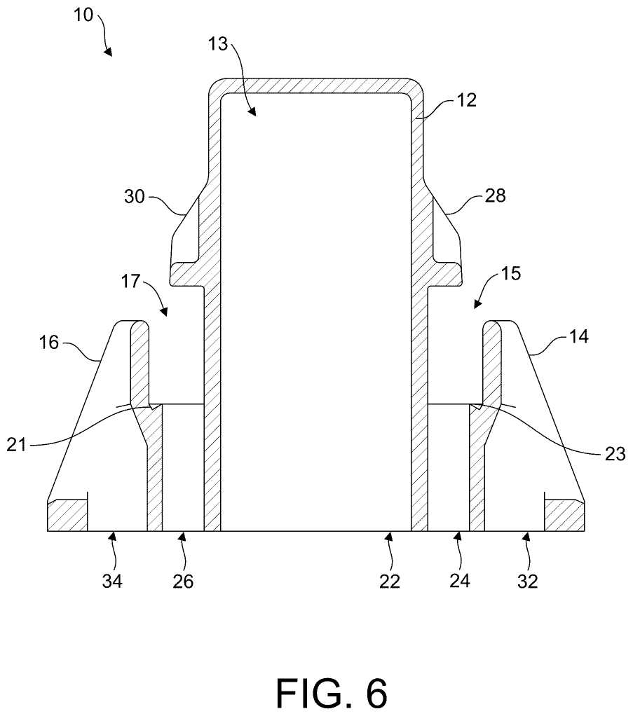

An exemplary aspect of a self-locking dust cap lockout device 10 is depicted in FIGS. 1-8. The self-locking dust cap lockout device 10 can be configured for use as a large-scale solar power plant solar connector lockout and dust prevention device that combines lockout and dust prevention members into a singular component. The self-locking dust cap lockout device 10 is configured to be coupled to solar connectors found across a large-scale solar plant.

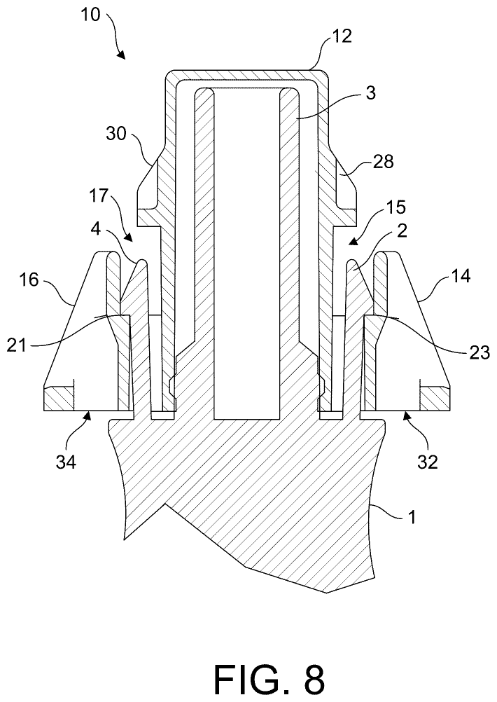

The self-locking dust cap lockout device 10 includes a round body 12, projection 14, projection 16, and tabs 18, 20. The round body 12 includes a through-bore 22, which allows access to the internal volume 13. The round body 12 is configured to act as a dust cap to protect the sensitive electrical components of a male adaptor 3 of a connector 1 (shown in FIG. 8). Arranged on the either side of the round body 12 are projections 28, 30. As described in detail below, the projections 28, 30 protect the tabs 2, 4 of a connector 1 when the locout device 10 is arranged on the connector 1 (shown in FIG. 8).

The projection 14 is arranged opposite the projection 16 on the round body 12, forming a channel 15, and including through-bores 24 and 32. The through-bore 24 is configured to allow the tab 2 of the connector 1 to pass into the lockout device 10. A ledge 23 can be positioned on an internal surface of the projection 14, and is configured to interact with the tab 2 once fully inserted into the channel 15. Once the tab 2 is passed through the through-bore 24, and arranged in the channel 15 between the projection 14 and the round body 12, the tab 2 engages with the ledge 23, preventing the tab 2 from being removed unless the tab 2 is deformed to disengage from the ledge 23. In this arrangement, the tab 2 is protected from outside elements by the projection 14 and the round body 12.

Additionally, the projection 16 forms the channel 17, and includes through-bores 26 and 34. The through-bore 26 is configured to allow the tab 4 of the connector 1 to pass into the lockout device 10. A ledge 21 can be positioned on an internal surface of the projection 16, and is configured to interact with the tab 4 once fully inserted into the channel 17. Once the tab 4 is positioned through the through-bore 26 and into the channel 17, the tab 4 engages with the ledge 21, preventing the tab 4 from being removed unless the tab 4 is deformed to disengage from the ledge 21. In this arrangement, the tab 4 is protected from outside elements by the projection 16 and the round body 12. Due to the arrangement of the projections 12, 14, in combination with the round body 12, the tabs 2, 4 are partially encapsulated within the channels 15 and 17, and can require a tool of some kind to deform the tabs 2, 4 in order to remove the connector 1 from the lockout device 10.

The through-bores 32, 34 are arranged on the projections 14, 16 respectively, and are configured to accept a further securement device, such a security band, safety tag, or zip tie, in order to prevent unauthorized removal of the lockout device 10 from the connector 1. Additionally, the tabs 18 and 20 can be integral with the lockout device 10, and are configured to provide a surface for pushing or pulling the device during removal. In an aspect, the round body 12, projections 14, 16, and tabs 18, 20 are integral with the lockout device 10. In an aspect, the round body 12, projections 14, 16, and tabs 18, 20 can vary in size and length to accommodate various solar connector types.

In an exemplary aspect, the self-locking dust cap lockout device 10 is manufactured as one single piece. The self-locking dust cap lockout device 10 can be manufactured by the plastic injection molding process or 3D printing process. The material the lockout device 10 can be made from can be a flexible and deformable polymer.

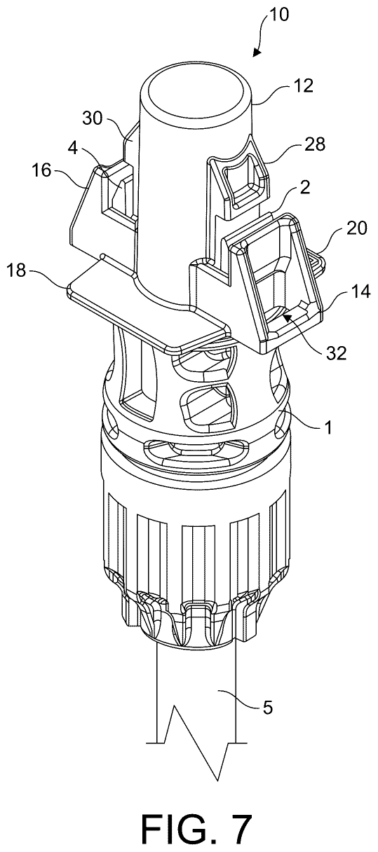

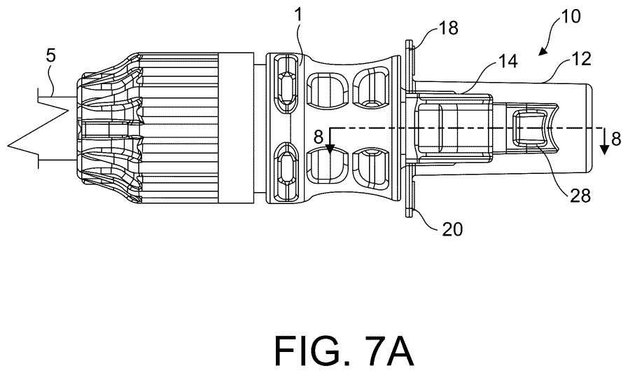

FIGS. 7-8 depict the self-locking dust cap lockout device 10 coupled with a male solar connector 1 having a wire 5. Even though one type of solar connector is depicted, other solar connector types can be used in combination with the self-locking dust cap lockout device 10. In order to properly position the self-locking dust cap lockout device 10 onto the solar connector 1, the mal adaptor 3 is inserted into the round body 12, and the tabs 2, 4 pass through the through-bores 24, 26, and couple with the ledges 21, 23 of the lockout device 10. The self-locking dust cap lockout device 10 can then only be removed with a solar connector disconnect tool which disengages the tabs 2, 4 from the ledges 21, 23. As stated above, after the self-locking dust cap lockout device 10 is installed on the solar connector 1, a safety tag can be coupled through the through-bores 32, 34.

The self-locking dust cap lockout device 10 can be configured to fit around larger or smaller solar connectors depending on the requirements of the deployed usage. For example, the round body may increase or decrease in diameter or length, or the large through-bore holes may increase or decrease in size or move position on the support body. This is advantageous as various solar connectors may be used depending on site specific requirements.

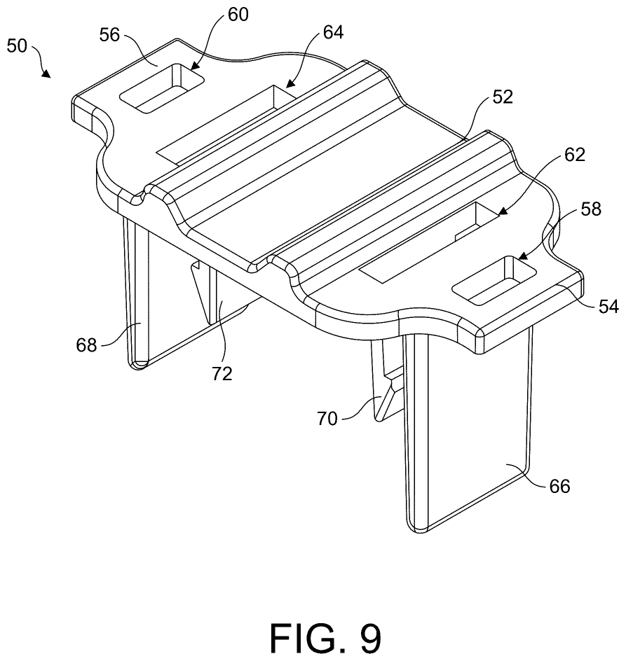

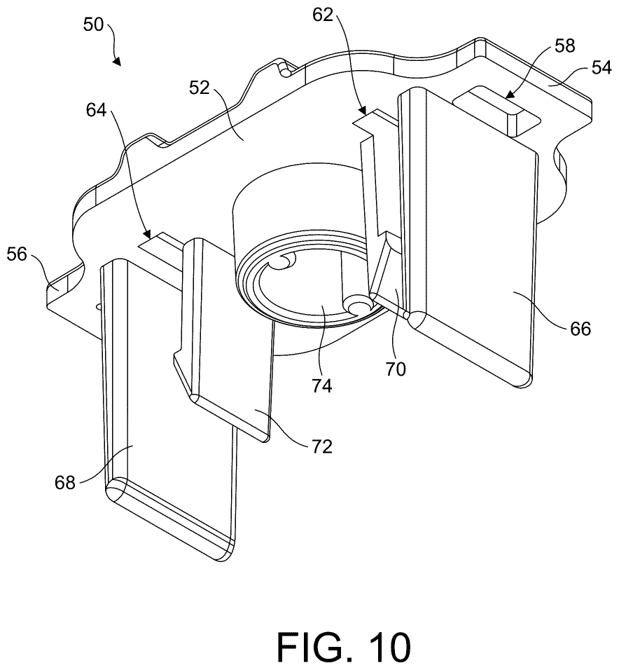

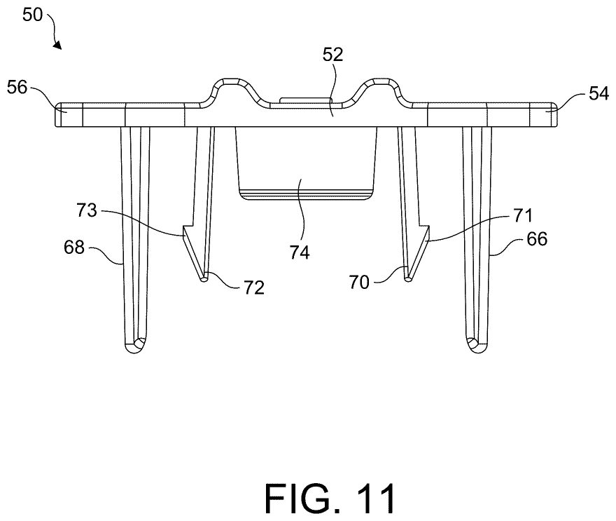

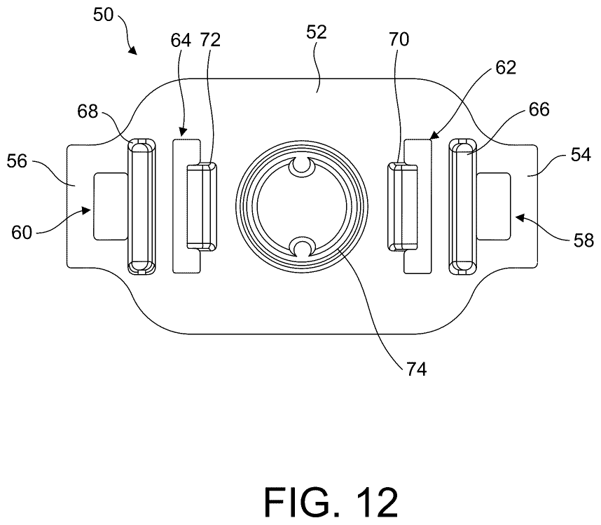

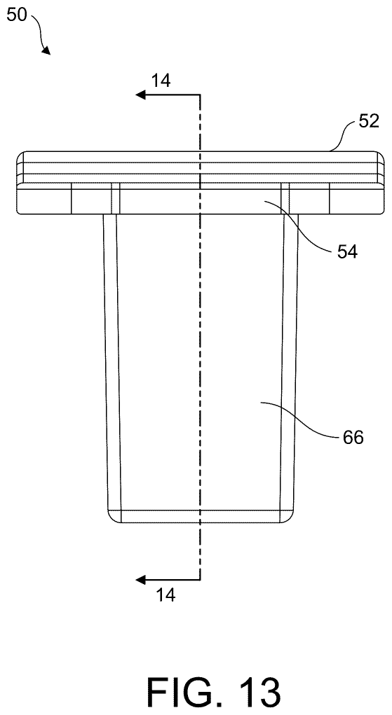

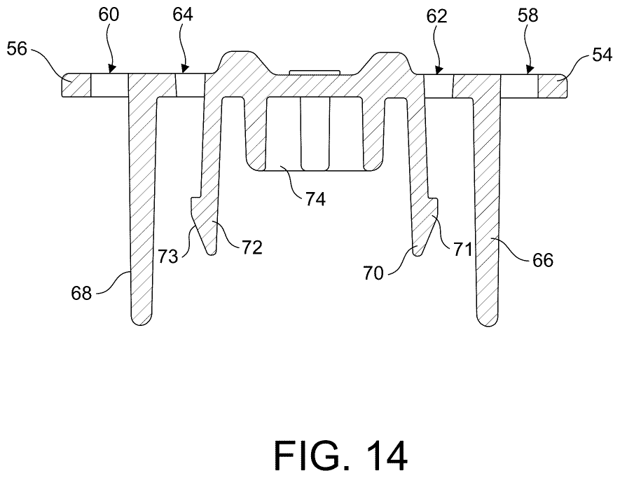

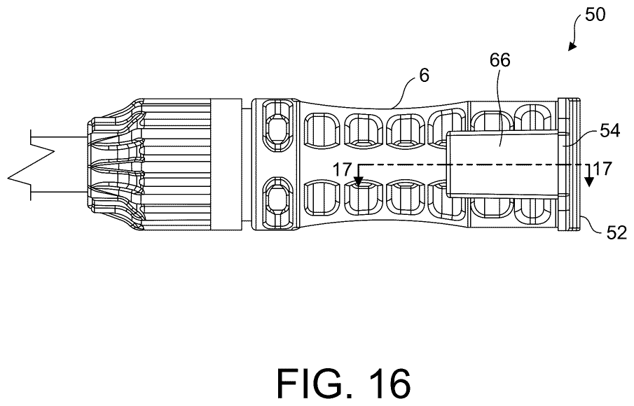

FIGS. 9-17 depict another aspect of a self-locking dust cap lockout device 50. The self-locking dust cap lockout device 50 can be configured for use as a large-scale solar power plant solar connector lockout and dust prevention device that combines lockout and dust prevention members into a singular component. The self-locking dust cap lockout device 50 is configured to be coupled primarily to female solar connectors found across a large-scale solar plant.

The lockout device 50 includes a support body 52, acts as a cover over a connector. The support body 52 also includes through-bores 62, 64, arranged on opposite sides of the round body 74, which allow a disconnect tool to be passed through the support body 52 in order to deform the locking tabs 70, 72. The self-locking dust cap lockout device 50 also includes a round hollow body 64, to act as a cap, locking tabs 70 and 72, to couple and lock together with the solar connector's locking holes, and side tabs 54, 56 with small through-bores 58, 60, for coupling a safety tag to the device as well as providing a surface for pushing or pulling the device during removal. Also positioned radially outside of the locking tabs 70, 72 are tabs 66, 68. The locking tabs 66, 68 provide additional protection to the connector 6 when the lockout device 50 is arranged on the connector 6.

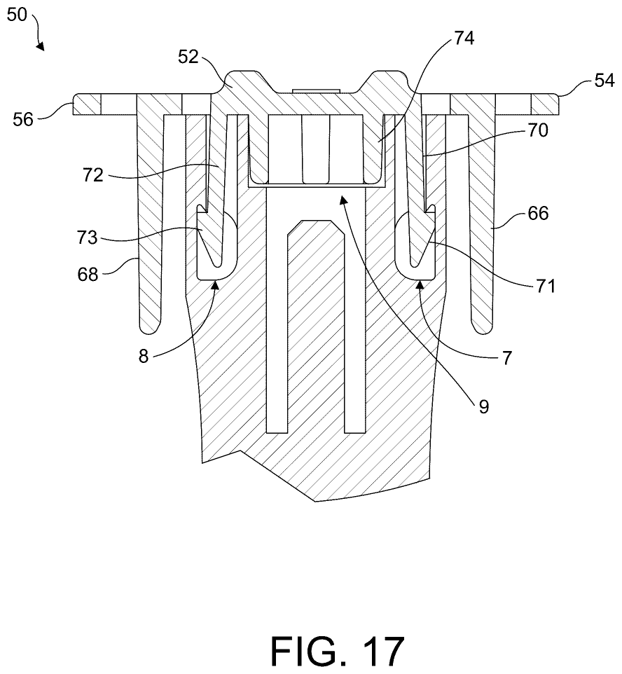

In an exemplary aspect, the round hollow body 74, tabs 66, 68, locking tabs 70, 71, and side tabs 54, 56 can be integral with the support body 52. The locking tabs 70, 72 each include a ledge 71, 73, respectively, in order to engage with a corresponding feature within the connector 6 (shown in FIG. 17). The locking tabs 70, 72, also are configured to allow the round hollow body 74 to be inserted over the connection point of a female solar connector 6, and couple with the locking holes of a female solar connector 6. Thus, the self-locking dust cap lockout device 50 is locked onto the solar connector 6 and cannot be removed without the use of a solar connector disconnect tool. In an exemplary aspect, the round hollow body 74, the support member 52, the tabs 66, 68, and locking tabs 70, 72 can vary in size and length to accommodate various solar connector types.

In an exemplary embodiment, the self-locking dust cap lockout device 50 is manufactured as one single piece. The self-locking dust cap lockout device 50 can be manufactured by the plastic injection molding process. The material the lockout device 50 can be made from can be a flexible and deformable polymer.

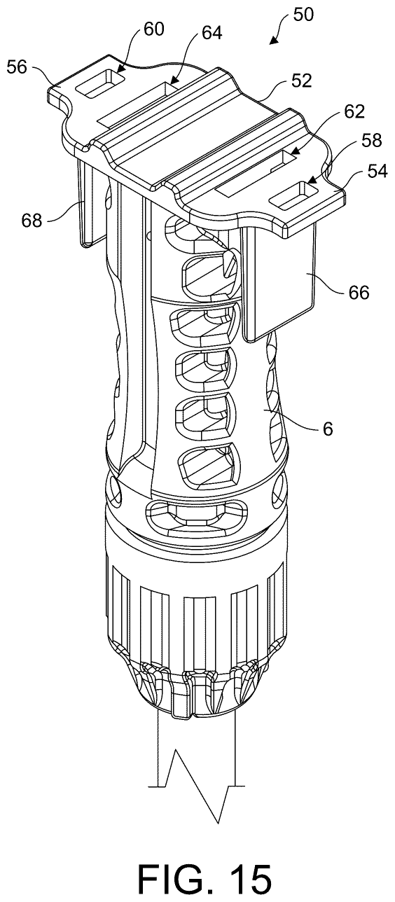

FIGS. 15-17 depict the self-locking dust cap lockout device 50 coupled with a female solar connector 6. Even though one type of solar connector is depicted, other solar connector types can be used in combination with the self-locking dust cap lockout device 50. In order to properly position the self-locking dust cap lockout device 50 onto the solar connector 6, the round hollow body 74 is inserted over the connection point of the connector 6, and the locking tabs 70, 72 pass into and allow ledges 71, 73 to engage with the corresponding features within the locking holes 7, 8 of the female solar connector 6 (shown in FIG. 17). The self-locking dust cap lockout device 50 can then only be removed with a solar connector disconnect tool which disengages the device's locking tabs 70, 72, with the locking holes of the female solar connector. After the self-locking dust cap lockout device 50 is installed on the solar connector, a safety tag can be coupled to the lockout device 50.

The self-locking dust cap lockout device 50 can be configured to fit around larger or smaller solar connectors depending on the requirements of the deployed usage. For example, the round hollow body may increase or decrease in diameter or length, or the locking tabs may increase or decrease in size or move position on the support body. This is advantageous as various solar connectors may be used depending on site specific requirements.

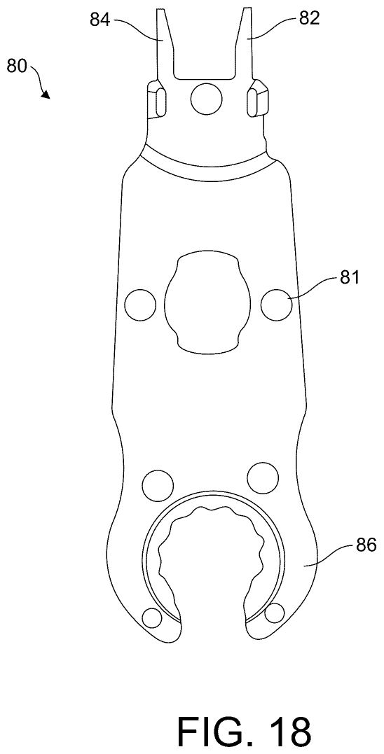

As stated above, a disconnect tool can be used to disengage the lockout devices from a connector. FIG. 18 depicts and exemplary embodiment of a disconnect tool 80. The disconnect tool 80 can include forks 82, 84 positioned on a distal end of a body 81, and a wrench 86 can be positioned opposite the forks 82, 84 on a proximal end of the body 81. The forks 82, 84 are configured such that an outer sloped surface of the forks 82, 84 contact the tabs of a connector or lockout device, and deform the tabs such that the tabs disengage from an ledge, releasing the lockout device from the connector.

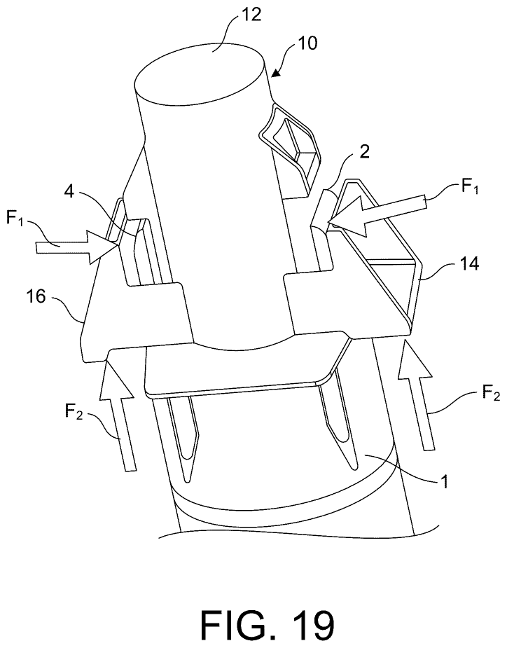

While in in use, a user would insert the forks 82, 84 into the connector or lockout device, and apply certain forces to remove the lockout device from the connector. For example, as depicted in FIG. 19, a user can use the disconnect tool 80 to deform the tabs 2, 4 of the connector, by applying forces F1 to deform the tabs 2, 4 inward towards the round body 12. This will disengage the tabs 2, 4 from the projections 14, 16. With the tabs 2, 4 disengaged, the user can apply a force F2 to slide the lockout device 10 off the connector 1.

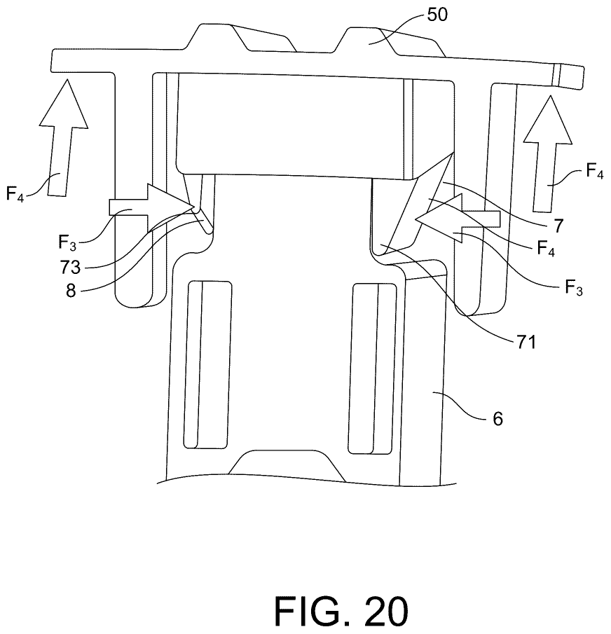

Similarly, FIG. 20 depicts the lockout device 50 secured to the connector 6. A user can use the disconnect tool 80 to deform the tabs 70, 72 of the lockout device 50, by applying force F3 with the disconnect tool 80, to deform the tabs 70, 72 inward. With the tabs 70, 72 disengaged, the user can apply a force F4 to slide the lockout device 50 off the connector 6.

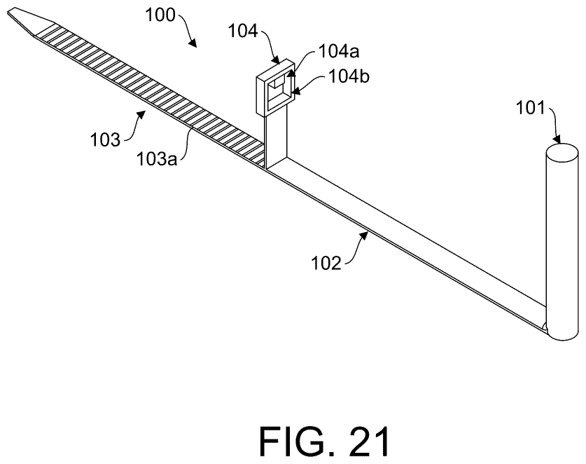

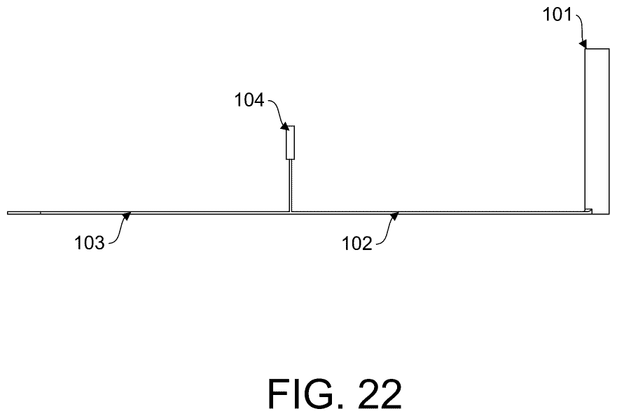

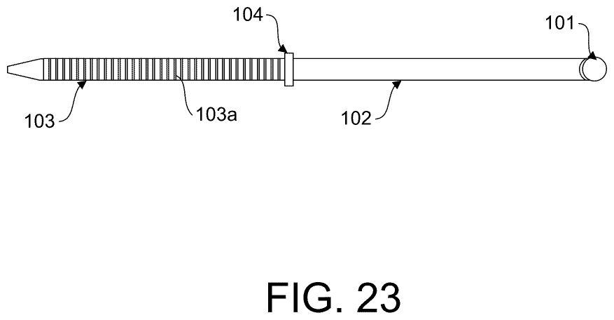

An exemplary aspect of a self-locking dust cap lockout device 100 is depicted in FIGS. 21-24. The self-locking dust cap lockout device 100 can be configured for use as a large-scale solar power plant solar connector lockout and dust prevention device that combines lockout and dust prevention members into a singular component. The self-locking dust cap lockout device 100 is configured to be coupled to solar connector found across a large-scale solar plant.

The self-locking dust cap lockout device 100 includes a round body 101, a extension body 102, an end tail 103, and a ratchet locking body 104. The round body 101 is a solid-cylindrical body that is configured to be arranged within a male side of a connector 110. The round body 101 includes a length that corresponds to the length of the extension body 102 such that when the round body 101 is inserted into the connector, the round body 101 cannot be backed out of the connector 110 due to the length of the extension body 102 being too short, as is explained in more detail below. In certain aspects, the round body 101 can have various lengths and diameters in order to properly secure to different sized connectors. Additionally, the round body 101 can be a hollow body having an aperture arranged therein such that the round body 101 fits fully over a connector 110. In an exemplary aspect, the round body 101, end tail 103, and ratchet locking body 104, are integral with the extension body 102. In an exemplary aspect the round body 101, the extension member 102, and the end tail 103, can vary in size and length to accommodate various solar connector types.

The extension body 102 can be a flexible member that allows the round body 100 to bend relative to the extension body 102, such that the round body 101 can be parallel with a portion of the extension body 102 when in a connected position on a connector 110. Arranged on the end of the extension body 102 is a ratchet locking body 104. The ratchet locking body 104 extends vertically upward from the extension body 102, and is substantially parallel to the round body 101 when in a disconnected position. The ratchet locking body 104 is flexible relative to the extension body 102 and such that the lockout device 100 can properly bend around a connector in a connected positioned. The ratchet body 104 can include a tooth 104a arranged within an opening 104b. The opening 104b is configured to let the end tail 103 pass therethrough, and the tooth 104a is configured to interact with ratcheting features arranged on the end tail 103, which are described in more detail below.

Corresponding with the ratchet locking body 104 and extending from the extension body 102 is the end tail 103. The end tail 103 can include rib ratchet features 103a. The rib ratchet features 103a, are configured to allow the end tail 103 to be inserted into the rachet locking body 104 in only one direction, thus allow the end tail 103 to be locked to the ratchet locking body 104. More specifically, the tooth 104a engages with the rib ratchet features 103a, which prevents the end tail 103 from being moved out of the opening 104 unless the tooth 104a is deformed to release form the rib ratchet features 103a. The locking operation of the ratchet body 104 and the end tail 103 can be similar to the locking design of a zip tie.

In an exemplary aspect, the self-locking dust cap lockout device 100 is manufactured as one single piece. The self-locking dust cap lockout device 100 can be manufactured by the plastic injection molding process or 3D printing process. However, the lockout device 100 can be formed from multiple components which are joined together at an assembly stage.

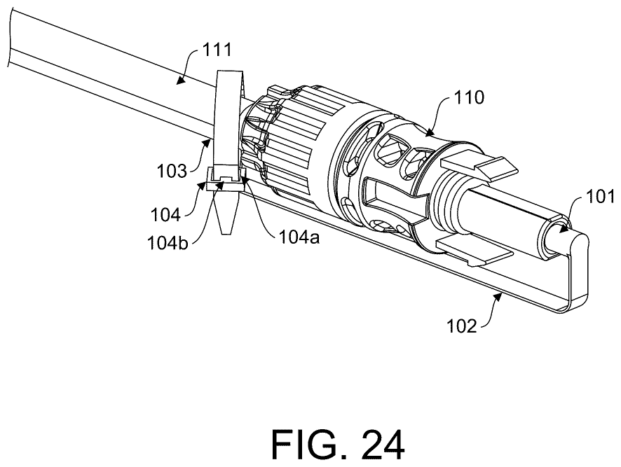

FIG. 24 depicts the self-locking dust cap lockout device 100 flexed and bent around a solar connector 110 and cable 111. Even though one type of solar connector size and cable size is depicted, other solar connector types and cable sizes can be in used in combination with the self-locking dust cap lockout device 100. In order to properly position the self-locking dust cap lockout device 100 onto the solar connector, the round body 101 is inserted to the connector 110 and the extension body 102 is extended past the connector 110. The end tail 103 is wrapped around the cable 111 and locked into position with the ratchet locking body 104. The self-locking dust cap lockout device 100 can then only be removed if the extension body 120 and/or the end tail 103 is cut to release the round body 102 from the connector 110.

As stated above, the round body 101 fits within the opening within the connector 110. Since the end tail 103 wraps around the cable 111 and tightens with the ratchet locking body 104, the diameter of the wrapped end tail 103 is smaller than the diameter of the connector 110. Therefore, if the round body 101 slides away from the connector 110 in a horizontal direction to remove the round body 101 from the connector 110, the wrapped end tail 103 would abut against the connector 110 where the cable 111 joins the connector 110. This prevents the round body 101 from moving in the horizontal direction more than a length that is equal to a difference between the extension body 102 and the length of the connector 110.

The self-locking dust cap lockout device 100 can be configured to fit around larger or smaller solar connectors as well as larger or smaller cables depending on the requirements of the deployed usage. For example, the round body 101 may increase or decrease in diameter or length, or the extension body may increase or decrease in length. This is advantageous as various solar connectors and cable sizes may be used depending on site specific requirements.

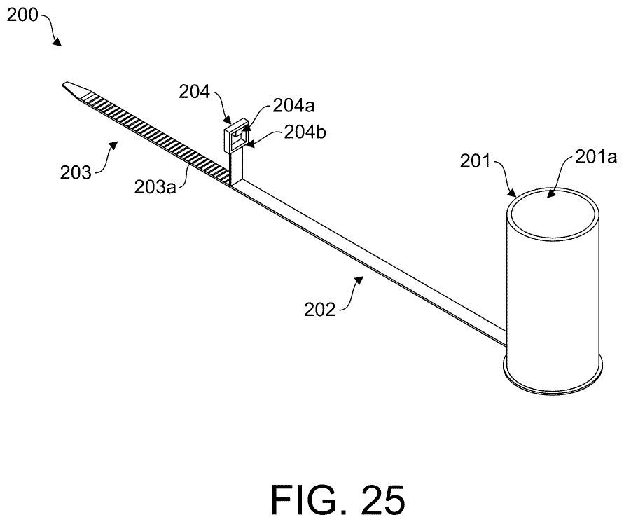

In one aspect, the round body of a lockout device can be configured as a hollow round body, rather than a solid plug. The hollow round body can act as a cap that fits around a portion of or the entire solar connector and can be configured to be compatible with both a male solar connector and a female solar connector. FIGS. 25-27 illustrate a self-locking dust cap lockout device 200. The lockout device 200 is sustainably similar to the lockout device 100 described above. Therefore, common features are not described in detail. The self-locking dust cap lockout device 200 includes a round body 201, an extension body 202, an end tail 203, and a ratchet locking body 204. The round body 201 is a hollow-cylindrical body having an opening 201a that is configured to be arranged around a connector 210. The ratchet body 204 can include a tooth 204a arranged within an opening 204b.

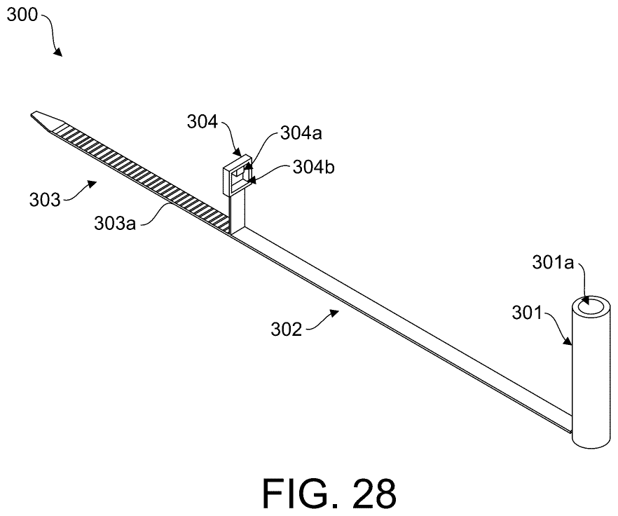

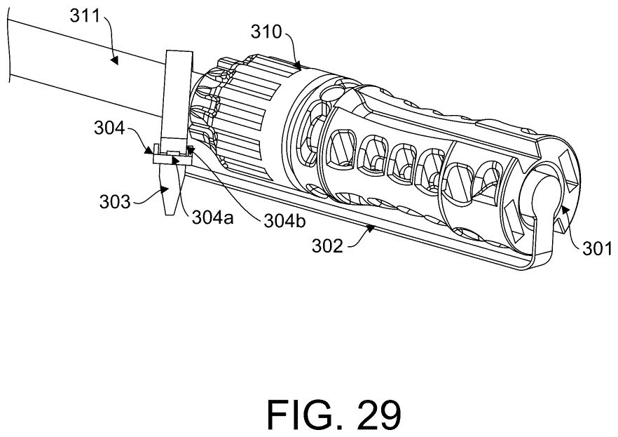

In another aspect, the round body of a lockout device can be a hollow body and be arranged within, not around a connector. FIGS. 28-29 illustrate a self-locking dust cap lockout device 300. The lockout device 300 is sustainably similar to the lockout device 200 described above. Therefore, like components are not described in detail. The self-locking dust cap lockout device 300 includes a round body 301, an extension body 302, an end tail 303, and a ratchet locking body 304. The round body 301 is a hollow-cylindrical body having an opening 301a that is configured to be arranged around an internal pin of a connector 310. The ratchet body 304 can include a tooth 304a arranged within an opening 304b.

In some aspects, the hollow round body can increase or decrease in diameter or length to be compatible with various connector types. In addition, multiple extension bodies, support bodies, and ratchet locking features can be added to the device so that the end tail can be locked in at various locations along the device such that the device is compatible with various connector lengths and sizes, as described in more detail below.

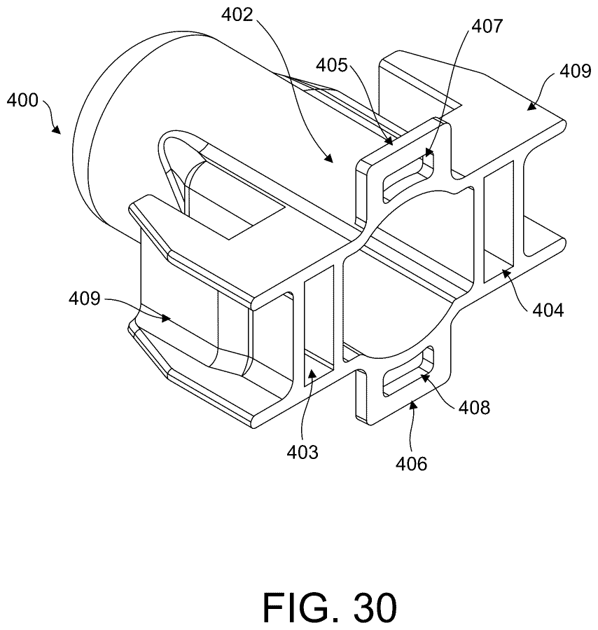

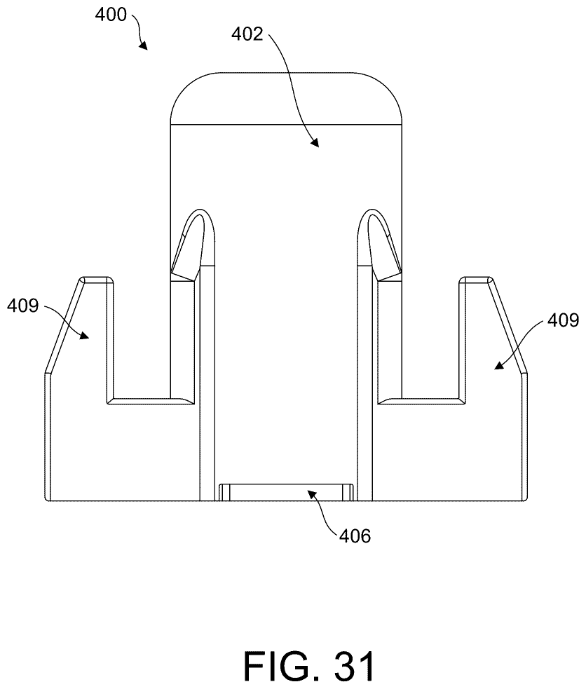

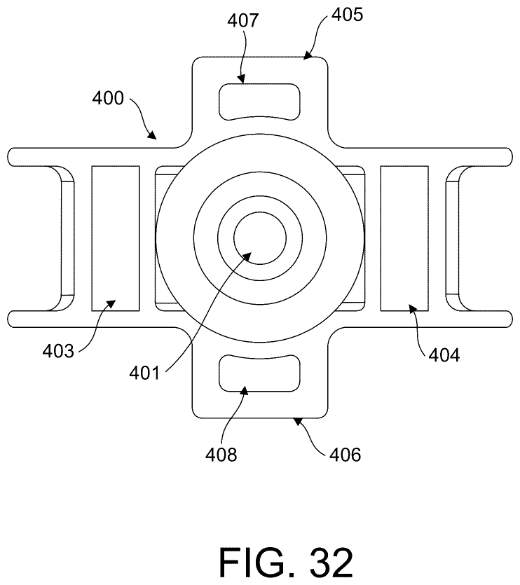

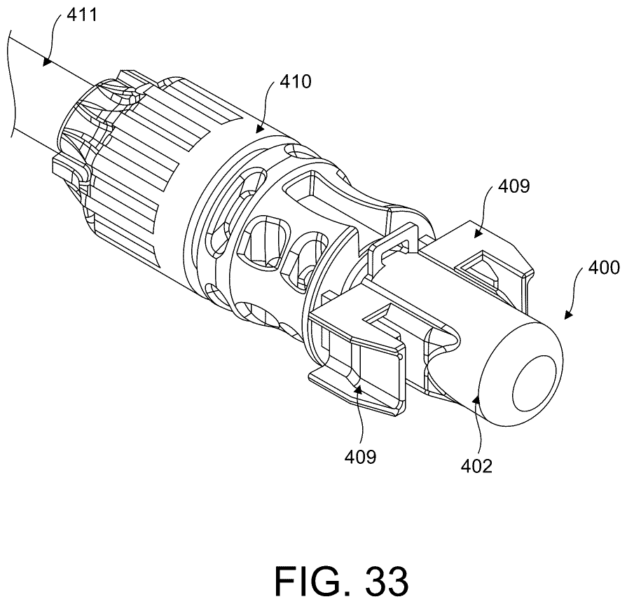

FIGS. 30-34 depict another aspect of a self-locking dust cap lockout device 400. The self-locking dust cap lockout device 400 can be configured for use as a large-scale solar power plant solar connector lockout and dust prevention device that combines lockout and dust prevention members into a singular component. The self-locking dust cap lockout device 400 is configured to be coupled to solar connector found across a large-scale solar plant. The self-locking dust cap lockout device 400 is different in design from the self-locking dust cap lockout device 100.

The self-locking dust cap lockout device 400, includes a round body 401, to act as a plug, a support body 402, with large through-bore holes 403 and 404, to couple and lock together with the solar connector's locking feature, side tabs 405 and 406, to obstruct and prevent misaligned engagement with the solar connector as well as provide a surface for pushing or pulling the device during removal, small through-bore holes 407 and 408, for coupling a safety tag to the device and protective tabs 409 arranged on the outer edges of the through-bore holes 403, 405. In an aspect, the round body 402, large through-bore holes 403 and 404, side tabs 405 and 406, small through-bore holes 407 and 408, and tabs 409 are integral with the support body 402. The through-bore holes 403 and 404, are configured to allow the round body 401 to be inserted into the connection point of a male solar connection and couple with the locking tabs of the male solar connector. Thus the self-locking dust cap lockout device 400 is locked onto the solar connector and cannot be removed without the use of a solar connector disconnect tool. In an aspect, the round body 401, the support member 402, the large-through-bore holes, 403 and 404, can vary in size and length to accommodate various solar connector types.

In an exemplary aspect, the self-locking dust cap lockout device 400 is manufactured as one single piece. The self-locking dust cap lockout device 400 can be manufactured by the plastic injection molding process or 3D printing process.

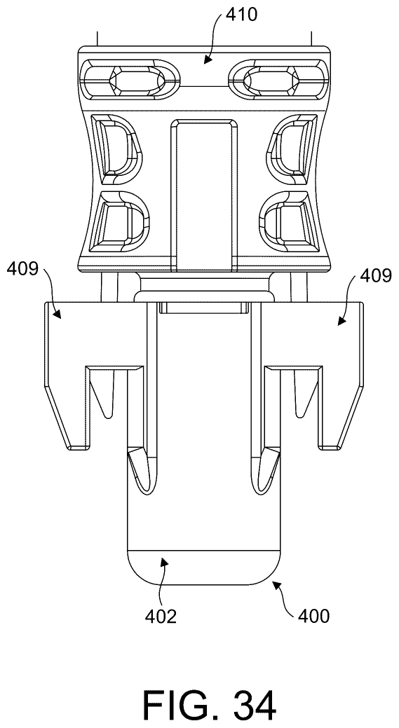

FIG. 34 depicts the self-locking dust cap lockout device 400 coupled with a male solar connector 410 having a wire 411. Even though one type of solar connector is depicted, other solar connector types can be used in combination with the self-locking dust cap lockout device 400. In order to properly position the self-locking dust cap lockout device 400 onto the solar connector 410, the round body 401 is inserted to the connector and the large-through bore holes is engaged and coupled with the locking tabs of the male solar connector. The self-locking dust cap lockout device 400 can then only be removed with a solar connector disconnect tool which disengages the solar connector locking tabs with the large through-bore holes 403 and 404. After the self-locking dust cap lockout device 400 is installed on the solar connector 410, a safety tag can be coupled through either small through-bore hole 407 and 408, or the side tabs 405 and 406, which can be designed to break off and shows visuals signs of tampering if an individual forcefully or incorrectly tries to remove the safety tag or self-locking dust cap lockout device 400.

The self-locking dust cap lockout device 400 can be configured to fit around larger or smaller solar connectors depending on the requirements of the deployed usage. For example, the round body may increase or decrease in diameter or length, or the large through-bore holes may increase or decrease in size or move position on the support body. This is advantageous as various solar connectors may be used depending on site specific requirements.

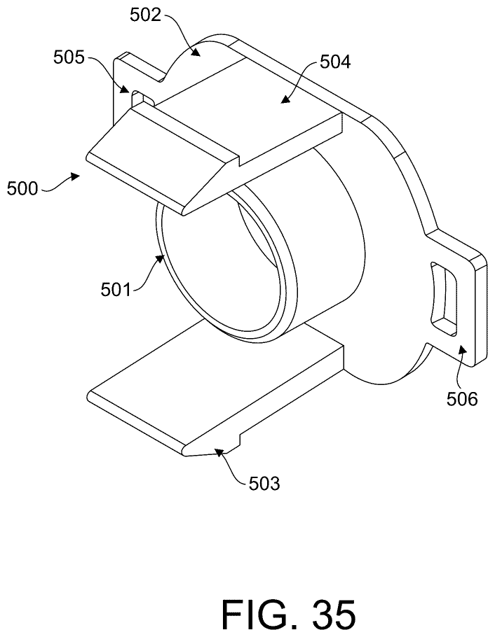

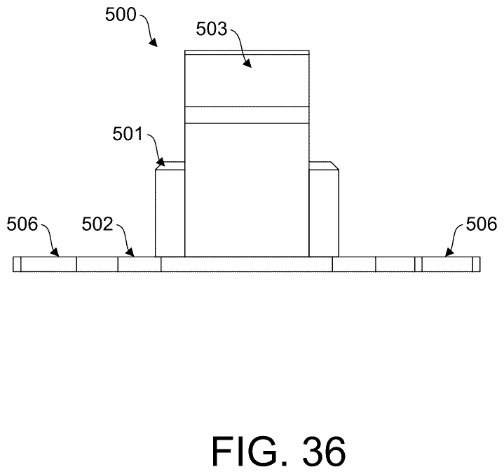

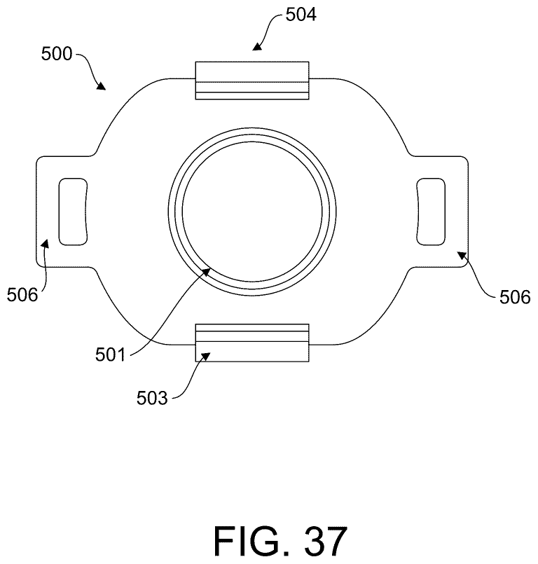

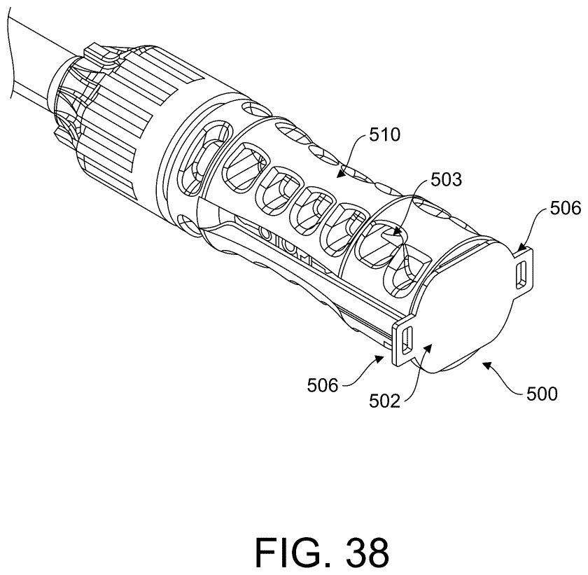

FIGS. 35-39 depict another aspect of a self-locking dust cap lockout device 500. The self-locking dust cap lockout device 500 can be configured for use as a large-scale solar power plant solar connector lockout and dust prevention device that combines lockout and dust prevention members into a singular component. The self-locking dust cap lockout device 500 is configured to be coupled primarily to female solar connectors found across a large-scale solar plant.

The self-locking dust cap lockout device 500, includes a round hollow body 501, to act as a cap, a support body 502, with locking tabs 503 and 504, to couple and lock together with the solar connector's locking holes, and side tabs with small through-bore holes 505 and 506, for coupling a safety tag to the device as well as providing a surface for pushing or pulling the device during removal. In an exemplary aspect, the round hollow body 502, locking tabs 503 and 504, and side tabs with small through-bore holes 505 and 506 are integral with the support body 502. The locking tabs 503 and 504, are configured to allow the round hollow body 501 to be inserted over the connection point of a female solar connection and couple with the locking holes of a female solar connector, thus the self-locking dust cap lockout device 500 is locked onto the solar connector and cannot be removed without the use of a solar connector disconnect tool. In an exemplary aspect the round hollow body 501, the support member 502, the locking tabs, 503 and 504, can vary in size and length to accommodate various solar connector types.

In an exemplary aspect, the self-locking dust cap lockout device 500 is manufactured as one single piece. The self-locking dust cap lockout device 500 can be manufactured by the plastic injection molding process.

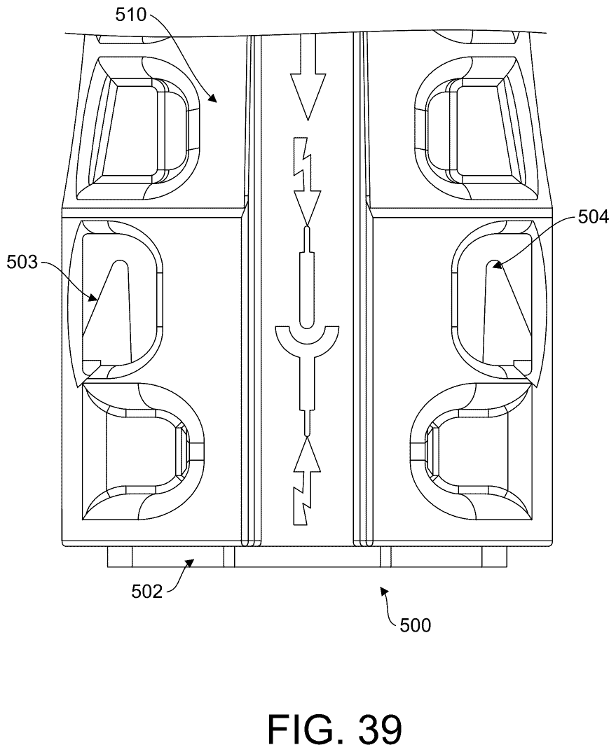

FIG. 39 depicts the self-locking dust cap lockout device 500 coupled with a female solar connector 510 having wire 511. Even though one type of solar connector is depicted, other solar connector types can be used in combination with the self-locking dust cap lockout device 500. In order to properly position the self-locking dust cap lockout device 500 onto the solar connector 510, the round hollow body 501 is inserted over the connection point of the connector and the locking features are engaged and coupled with the locking holes of the female solar connector 510. The self-locking dust cap lockout device 500 can then only be removed with a solar connector disconnect tool which disengages the device's locking tabs 503 and 504 with the locking holes of the female solar connector. After the self-locking dust cap lockout device 500 is installed on the solar connector, a safety tag can be coupled to either side tap 505 or 506, the side tabs 505 and 506 can be designed to break off and shows visuals signs of tampering if an individual forcefully or incorrectly tries to remove the safety tag or self-locking dust cap lockout device 500.

The self-locking dust cap lockout device 500 can be configured to fit around larger or smaller solar connectors depending on the requirements of the deployed usage. For example, the round hollow body may increase or decrease in diameter or length, or the locking tabs may increase or decrease in size or move position on the support body. This is advantageous as various solar connectors may be used depending on site specific requirements.

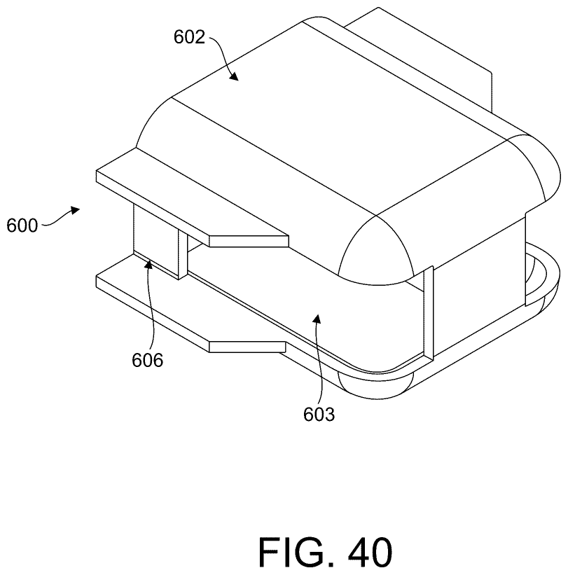

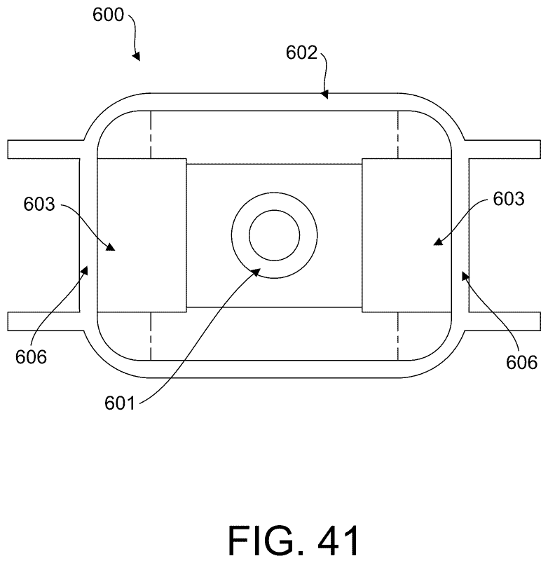

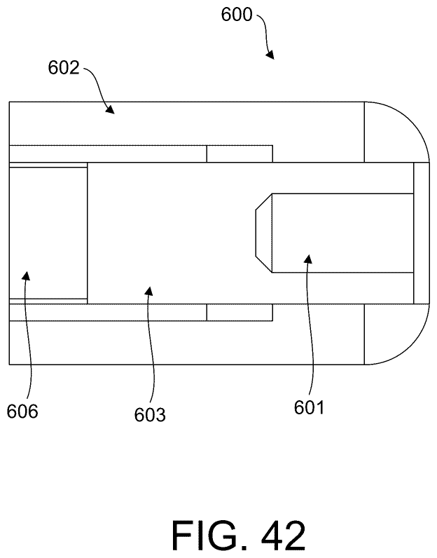

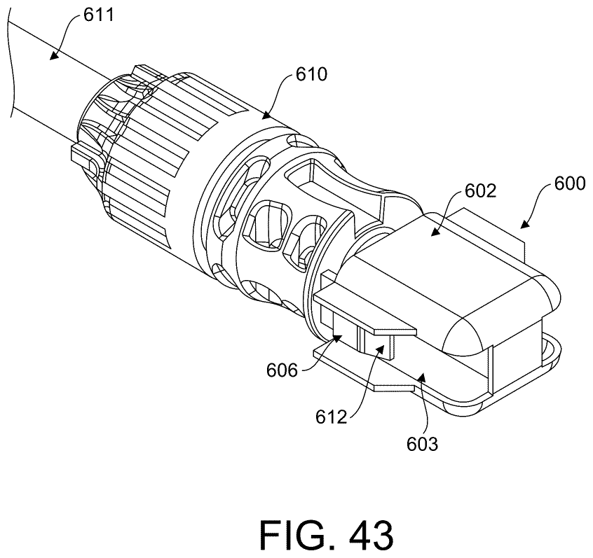

FIGS. 40-43 depict another aspect of a self-locking dust cap lockout device 900. The self-locking dust cap lockout device 600 is substantially similar to the self-locking dust cap lockout device 400, and therefore common features are not described in detail herein. A person skilled in the art would appreciate that the above description of the self-locking dust cap lockout device 400 is also applicable to the additional self-locking dust cap lockout device 600. The self-locking dust cap lockout device 600, includes cylindrical body 601 to be inserted into the connector 610 having a wire 611, a support body 602, through-bore holes 603 and extensions 606, to couple and lock together with the locking features of the solar connector 610. Device 600 differs from device 400 in that a custom specialized tool would be required to remove the device from the solar connector.

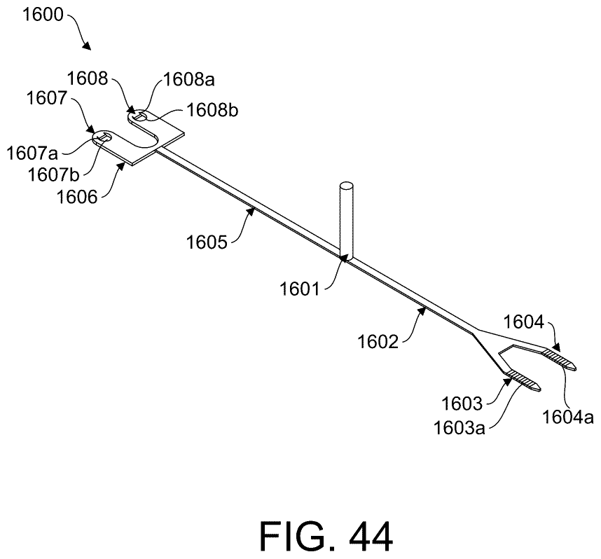

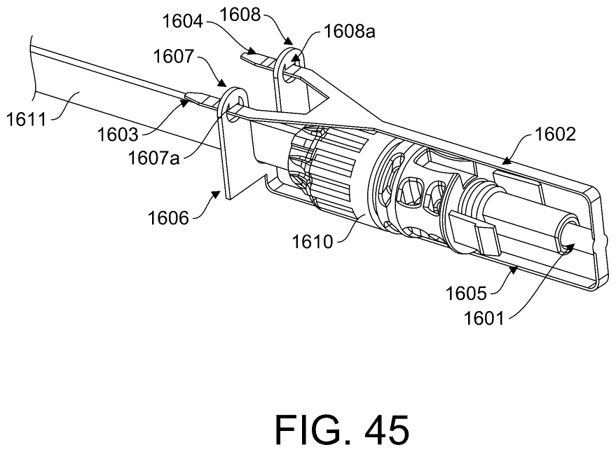

FIGS. 44-45 depict another aspect of a self-locking dust cap lockout device 1600. The self-locking dust cap lockout device 1600 is substantially similar to the self-locking dust cap lockout device 100, and therefore common features are not described in detail herein. A person skilled in the art would appreciate that the above description of the self-locking dust cap lockout device 100 is also applicable to the additional self-locking dust cap lockout device 1600. The self-locking dust cap lockout device 1600 can be configured for use as a large-scale solar power plant solar connector lockout and dust prevention device that combines lockout and dust prevention members into a singular component. The self-locking dust cap lockout device 1600 is configured to be coupled to solar connector found across a large-scale solar plant.

The self-locking dust cap lockout device 1600 includes a round body 1601, a first extension body 1602, a first end tail 1603, a second end tail 1604, a second extension body 1605, and a support body 1606 with a first ratchet locking body 1607 having a tooth 1607a and an opening 1607b, and a second ratchet locking body 1608 having a tooth 1608a and an opening 1608b. Additionally, the end tails 1603, 1604 have rib ratchet features 1603a and 1604a. In an aspect, the round body 1601, end tails 1603 and 1604, and rachet locking bodies 1607 and 1608, are integral with the extension bodies 1602 and 1605. The rib ratchet features 1603a, and 1604a are configured to allow the end tails 1603 and 1604 to be inserted into the rachet locking bodies 1606 and 1607 in only one direction, thus allow the end tails 1603 and 1604 to be locked to the ratchet locking feature 1606 and 1607. In an exemplary aspect the round body 1601, the extension members 1602 and 1605, and the end tails 1603 and 1604, can vary in size and length to accommodate various solar connector types.

In an exemplary aspect, the self-locking dust cap lockout device 1600 is manufactured as one single piece. The self-locking dust cap lockout device 1600 can be manufactured by the plastic injection molding process or 3D printing process.

FIG. 45 depicts the self-locking dust cap lockout device 1600 flexed, bent, and locked into position around a solar connector and cable. Even though one type of solar connector and cable size is depicted, other solar connector types and cable sizes can be in used in combination with the self-locking dust cap lockout device 1600.

In order to properly position the self-locking dust cap lockout device 1600 onto the solar connector 1610, the round body 1601 is inserted to the connector and the second extension body 1605 is extended past the connector, the support body 1606 is positioned around the cable 1611, the first extension body 1602 is extended towards the end of the connector and the end tails 1603 and 1604 are locked into position with the rachet locking bodies 1607 and 1608. The self-locking dust cap lockout device 1600 can then only be removed if one of the extension bodies or end tails is cut down.

The self-locking dust cap lockout device 1600 can be configured to fit around larger or smaller solar connectors as well as larger or smaller cables depending on the requirements of the deployed usage. For example, the round body may increase or decrease in diameter or length, or the extension body may increase or decrease in length. This is advantageous as various solar connectors and cable sizes may be used depending on site specific requirements. The round body member 1601 can also be configured as a hollow round body, rather than a solid plug. The hollow round body can act as a cap that fits around a portion of or the entire solar connector and can be configured to be compatible with both a male solar connector and a female solar connector. The hollow round body can increase or decrease in diameter or length to be compatible with various connector types. In addition, multiple extension bodies, support bodies, and ratchet locking features can be added to the device so that the end tail can be locked in at various locations along the device such that the device is compatible with various connector lengths and sizes

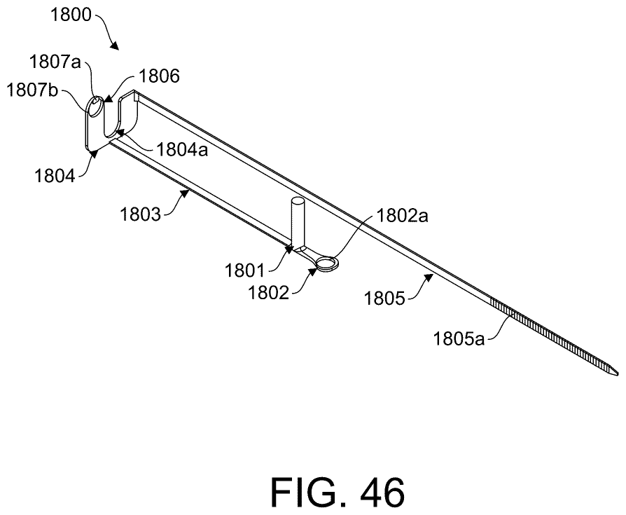

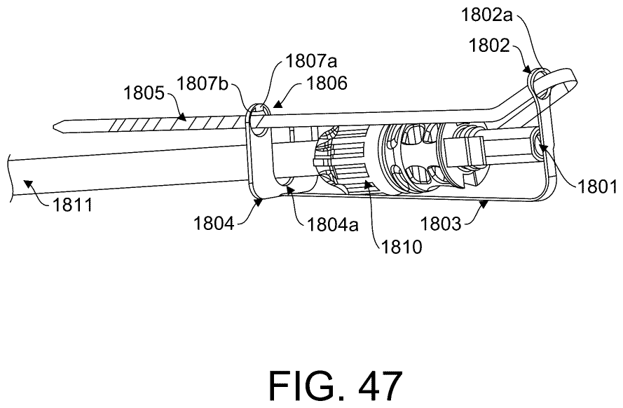

FIGS. 46-47 depict another aspect of a self-locking dust cap lockout device 1800. The self-locking dust cap lockout device 1800 is substantially similar to the self-locking dust cap lockout device 1600, and therefore common features are not described in detail herein. A person skilled in the art would appreciate that the above description of the self-locking dust cap lockout device 100 is also applicable to the additional self-locking dust cap lockout device 1800. The self-locking dust cap lockout device 1800 can be configured for use as a large-scale solar power plant solar connector lockout and dust prevention device that combines lockout and dust prevention members into a singular component. The self-locking dust cap lockout device 1800 is configured to be coupled to solar connector found across a large-scale solar plant.

The self-locking dust cap lockout device 1800 includes a round body 1801, a through-bore hole 1802, extended out from the round body, an extension body 1803, a support body 1804 having a slot 1804a, an end tail 1805, and a ratchet locking body 1806 including a tooth 1807a and an opening 1807b. Additionally, the end tail 1805 has rib ratchet features 1805a. In an aspect, the round body 1801, through-bore hole 1802, support body 1804, end tail 1805, and rachet locking body 1806 are integral with the extension body 1803. The rib ratchet features 1805a are configured to allow the end tail 1805 to be inserted into the rachet locking bodies 1806 in only one direction, thus allowing the end tail 1805 to be locked to the ratchet locking feature 1806. In an exemplary aspect the round body 1801, the extension body 1803, and the end tail 1805, can vary in size and length to accommodate various solar connector types.

In an exemplary aspect, the self-locking dust cap lockout device 1800 is manufactured as one single piece. The self-locking dust cap lockout device 1800 can be manufactured by the plastic injection molding process or 3D printing process.

FIG. 47 depicts the self-locking dust cap lockout device 1800 flexed, bent, and locked into position around a solar connector 1810 and cable 1811. Even though one type of solar connector and cable size is depicted, other solar connector types and cable sizes can be in used in combination with the self-locking dust cap lockout device 1800.

In order to properly position the self-locking dust cap lockout device 1800 onto the solar connector 1810, the round body 1801 is inserted to the connector 1810 and the extension body 1803 is extended past the connector, the support body 1804 is positioned around the cable 1811 by positioning the cable 1811 within the slot 1804a, the first extension body 1804 is extended towards the end of the connector and the end tail 1805 is looped through the through-bore hole 1802. The end tail 1805 is locked into position with the rachet locking body 1806. The self-locking dust cap lockout device 1800 can then only be removed if the end tail 1805 is cut down.

The self-locking dust cap lockout device 1800 can be configured to fit around larger or smaller solar connectors as well as larger or smaller cables depending on the requirements of the deployed usage. For example, the round body may increase or decrease in diameter or length, or the extension body may increase or decrease in length. This is advantageous as various solar connectors and cable sizes may be used depending on site specific requirements. The round body member 1801 can also be configured as a hollow round body, rather than a solid plug. The hollow round body can act as a cap that fits around a portion of or the entire solar connector and can be configured to be compatible with both a male solar connector and a female solar connector. The hollow round body can increase or decrease in diameter or length to be compatible with various connector types.

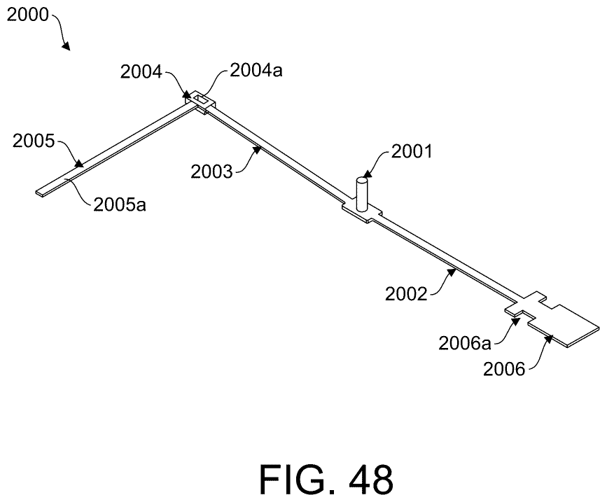

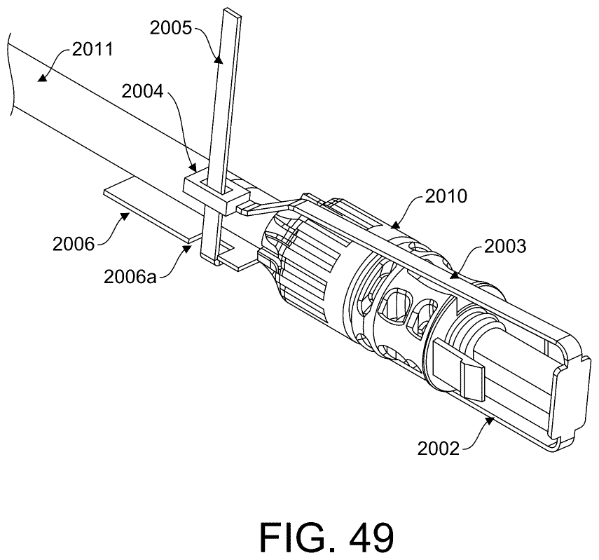

FIGS. 48-49 depict another aspect of a self-locking dust cap lockout device 2000. The self-locking dust cap lockout device 2000 is substantially similar to the self-locking dust cap lockout device 100, and therefore common features are not described in detail herein. A person skilled in the art would appreciate that the above description of the self-locking dust cap lockout device 100 is also applicable to the additional self-locking dust cap lockout device 2000. The self-locking dust cap lockout device 2000 can be configured for use as a large-scale solar power plant solar connector lockout and dust prevention device that combines lockout and dust prevention members into a singular component. The self-locking dust cap lockout device 2000 is configured to be coupled to solar connector found across a large-scale solar plant.

The self-locking dust cap lockout device 2000 includes a round body 2001, a first extension body 2002, a second extension body 2003, a ratchet locking body 2004 having an opening 2004a and a tooth (not shown), an end tail 2005, and a notched tag body 2006 having anotch 2006a. Additionally, the end tail has rib ratchet features 2005a. In an exemplary aspect, the round body 2001, end tail 2005, and rachet locking body 2004, are integral with the extension bodies 2002 and 2003. The rib ratchet features 2005a are configured to allow the end tail 2005 to be inserted into the rachet locking body 2004 in only one direction, thus allowing the end tail 2005 to be locked to the ratchet locking feature 2004. In an exemplary aspect the round body 2001, the extension bodies 2002 and 2003, and the end tail 2005, can vary in size and length to accommodate various solar connector types. In an exemplary aspect the notched tag body 2006 can vary in size and length to accommodate various tag or inscription sizes.

In an exemplary aspect, the self-locking dust cap lockout device 2000 is manufactured as one single piece. The self-locking dust cap lockout device 2000 can be manufactured by the plastic injection molding process or 3D printing process.

FIG. 49 depicts the self-locking dust cap lockout device 2000 flexed, bent, and locked into position around a solar connector and cable. Even though one type of solar connector and cable size is depicted, other solar connector types and cable sizes can be in used in combination with the self-locking dust cap lockout device 2000.

In order to properly position the self-locking dust cap lockout device 2000 onto the solar connector, the round body 2001 is inserted into the connector and both extended bodies 2002 and 2003 are extended past the connector, the end tail 2005 is wrapped with the notch 2006a and around the notched tag body 2006. The end tail 2005 is then locked into position with the rachet locking body 2004. The self-locking dust cap lockout device 2000 can then only be removed if the end tail 2005 is cut. While the end tail 2005 is cut, the notched tag body 2006 provides protection from damage from the cutting device used.

The self-locking dust cap lockout device 2000 can be configured to fit around larger or smaller solar connectors as well as larger or smaller cables depending on the requirements of the deployed usage. For example, the round body may increase or decrease in diameter or length, or the extension body may increase or decrease in length. This is advantageous as various solar connectors and cable sizes may be used depending on site specific requirements. The round body member 2001 can also be configured as a hollow round body, rather than a solid plug. The hollow round body can act as a cap that fits around a portion of or the entire solar connector and can be configured to be compatible with both a male solar connector and a female solar connector. The hollow round body can increase or decrease in diameter or length to be compatible with various connector types. In addition, multiple extension bodies, support bodies, and ratchet locking features can be added to the device so that the end tail can be locked in at various locations along the device such that the device is compatible with various connector lengths and sizes

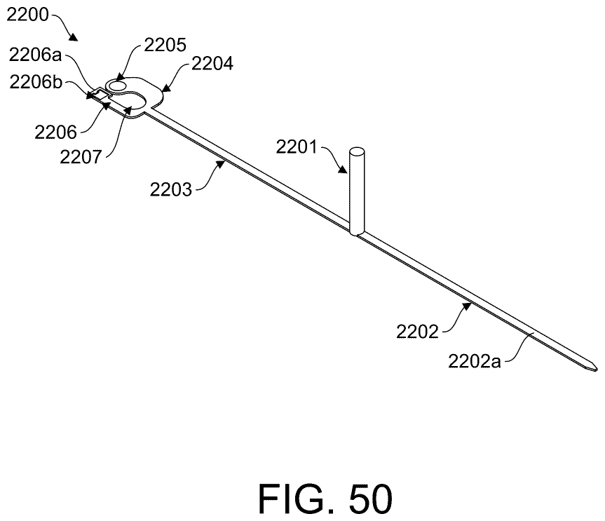

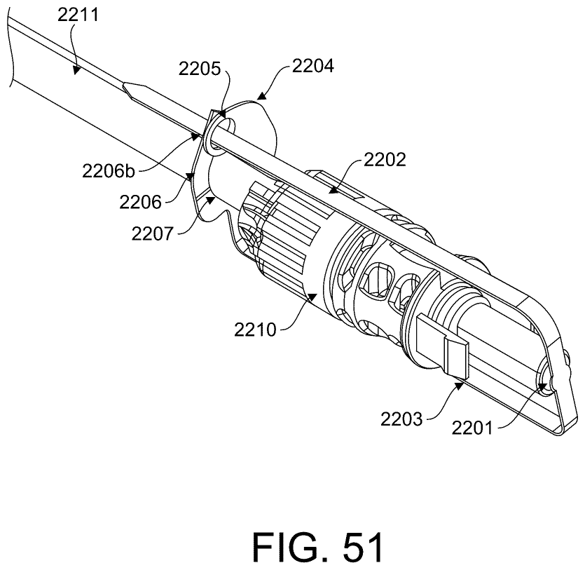

FIGS. 50-51 depict another aspect of a self-locking dust cap lockout device 2200. The self-locking dust cap lockout device 2200 is substantially similar to the self-locking dust cap lockout device 100, and therefore common features are not described in detail herein. A person skilled in the art would appreciate that the above description of the self-locking dust cap lockout device 100 is also applicable to the additional self-locking dust cap lockout device 2200. The self-locking dust cap lockout device 2200 can be configured for use as a large-scale solar power plant solar connector lockout and dust prevention device that combines lockout and dust prevention members into a singular component. The self-locking dust cap lockout device 2200 is configured to be coupled to solar connector found across a large-scale solar plant.

The self-locking dust cap lockout device 2200 includes a round body 2201, an end tail 2202, an extension body 2203, a support body 2204 having a through bore hole 2205 arranged therein, a ratchet locking body 2206 having a tooth 2206a and an opening 2206b arranged therein, and a slot 2207 positioned between the support body 2004 and the ratchet locking body 2206. Additionally, the end tail 2203 has rib ratchet features 2202a. In an exemplary aspect, the round body 2201, the end tail 2202, the extension body 2203, the support body 2204, and the ratchet locking body 2206 are integral with each other. The rib ratchet features 2202a are configured to allow the end tail 2202 to be inserted into the rachet locking bodies 2206 in only one direction, thus allowing the end tail 2202 to be locked to the ratchet locking feature 2206. In an exemplary aspect the round body 2201, the extension body 2203, and the end tail 2205, can vary in size and length to accommodate various solar connector types.

In an exemplary aspect, the self-locking dust cap lockout device 2200 is manufactured as one single piece. The self-locking dust cap lockout device 2200 can be manufactured by the plastic injection molding process or 3D printing process.

FIG. 51 depicts the self-locking dust cap lockout device 2200 flexed, bent, and locked into position around a solar connector and cable. Even though one type of solar connector and cable size is depicted, other solar connector types and cable sizes can be in used in combination with the self-locking dust cap lockout device 2200.

In order to properly position the self-locking dust cap lockout device 2200 onto the solar connector 2210, the round body 2201 is inserted to the connector 2210 and the extension body 2203 is extended past the connector 2210. The cable 2211 is positioned within the slot 2207 of the support body 2204 such that the support body 2204 and the ratchet locking feature 2206 is positioned around the cable 2211. The through-bore hole 2205 and opening 2206b are aligned such that the end tail 2202 is looped through both the through-bore hole 2205 and the opening 2206b. The end tail 2202 is then locked into position with the rachet locking body 2206. The self-locking dust cap lockout device 2200 can then only be removed if the end tail is cut down.

The self-locking dust cap lockout device 2200 can be configured to fit around larger or smaller solar connectors as well as larger or smaller cables depending on the requirements of the deployed usage. For example, the round body may increase or decrease in diameter or length, or the extension body may increase or decrease in length. This is advantageous as various solar connectors and cable sizes may be used depending on site specific requirements. The round body member 2201 can also be configured as a hollow round body, rather than a solid plug. The hollow round body can act as a cap that fits around a portion of or the entire solar connector and can be configured to be compatible with both a male solar connector and a female solar connector. The hollow round body can increase or decrease in diameter or length to be compatible with various connector types. In addition, multiple extension bodies, support bodies, and ratchet locking features can be added to the device so that the end tail can be locked in at various locations along the device such that the device is compatible with various connector lengths and sizes.

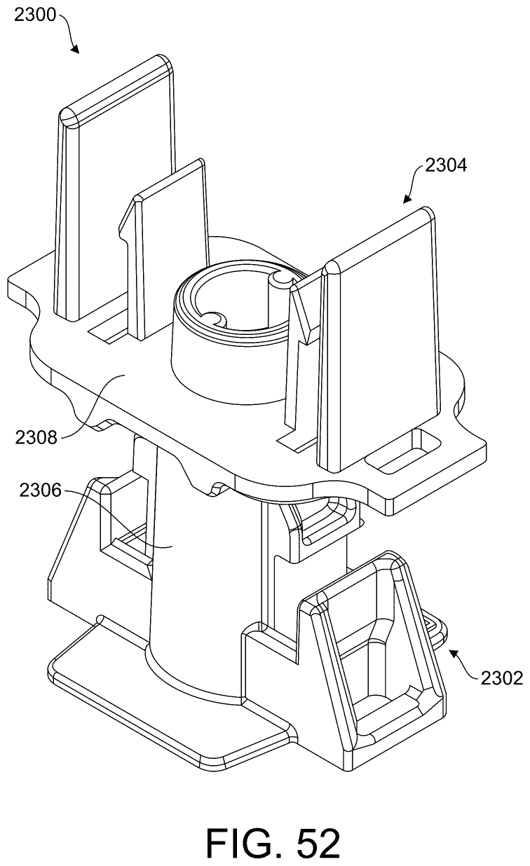

FIG. 52 depicts another aspect of a self-locking dust cap lockout device for a solar connector. The lockout device 2300 includes portion 2302 and portion 2304. Portion 2302 is substantially identical to the lockout device 10, depicted in FIGS. 1-8. Additionally, portion 2304 is substantially identical to the lockout device 50, depicted in FIGS. 9-17. Therefore, like components will not be described in detail. The portions 2302 and 2304 are connected together along the end of the round body 2306 and the support body 2308. The portions can be formed integrally together, or can be bonded together using known bonding techniques. While the portions 2302, 2304 are shown in a vertical arrangement, other arrangements are possible and considered within the scope of this disclosure. For example, the portions 2302, 2304 can be arranged horizontal relative to one another.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A device, comprising:
a body extending between a proximal end and a distal end, and having an interior volume therein;
a first projection extending from the body at the distal end, and including a first through-bore, wherein the first projection forms a first channel with the body;
a first ledge positioned within the first channel and on the first projection, the first ledge extending towards the body;
a second projection extending from the body at the distal end, opposite the first projection, and including a second through-bore, wherein the second projection forms a second channel with the body; and
a second ledge positioned within the second channel and on the second projection, the second ledge extending towards the body.

2. The device of claim 1, wherein the body includes a third projection extending from the body and positioned vertically above the first channel.

3. The device of claim 2, wherein the body includes a fourth projection extending from the body, opposite the third projection, and positioned vertically above the second channel.

4. The device of claim 3, wherein a first gap is positioned between the first projection and the third projection.

5. The device of claim 4, wherein a second gap is positioned between the second projection and the fourth projection.

6. The device of claim 1, further comprising a first tab extending from the distal end of the body, and a second tab extending from the distal end of the body, opposite the first tab.

7. The device of claim 1, wherein the first ledge and the second ledge are configured to abut against corresponding features of a connector arranged within the first channel and the second channel.

8. The device of claim 1, wherein the interior volume is configured to receive a portion of a connector.

9. The device of claim 1, wherein a third through-bore is positioned radially outward of the first through-bore.

10. The device of claim 9, wherein a fourth through-bore is positioned radially outward of the second through-bore.

11. The device of claim 1, wherein the body includes a sealing surface configured to abut a portion of a connector to form a seal between the body and the connector.

12. A device, comprising:
a support body extending between a first end and a second end;
a round body extending from the support body;
a first locking tab positioned on the first end of the support body, extending from the support body, and including a first ledge;
a first through-bore positioned in the support body and vertically above the first ledge;
a second locking tab positioned on the second end of the support body, opposite the hollow body, extending from the support body, and including a second ledge;
a second through-bore positioned in the support body and vertically above the second ledge;
a first tab extending from the body at the first end, radially outward of the first locking tab; and
a second tab extending from the body at the second end, radially outward of the second locking tab.

13. The device of claim 12, wherein the first locking tab and the second locking tab are deformable relative to the support body.

14. The device of claim 12, wherein the first locking tab and the second locking tab are configured to extend into a plurality of channels of a connector.

15. The device of claim 14, wherein the first ledge and the second ledge are configured to abut against corresponding features within the plurality of channels.

16. The device of claim 15, wherein the round body is configured to seal a port of the connector with the first and second ledge abutting the corresponding features.

17. The device of claim 12, wherein the first tab extends from the support body a length greater than the first locking tab.

18. The device of claim 12, wherein the second tab extends from the support body a length greater than the second locking tab.

19. The device of claim 12, wherein a third through-bore is positioned radially outward of the first through-bore.

20. The device of claim 12, wherein a fourth through-bore is positioned radially outward of the second through-bore.

21. The device of claim 12, wherein the support body includes a sealing surface configured to abut a portion of a connector to form a seal between the body and the connector.

22. A device, comprising:
a first portion, comprising:
a body extending between a proximal end and a distal end, and having an interior volume therein;
a first projection extending from the body at the distal end, and including a first through-bore, wherein the first projection forms a first channel with the body;
a first ledge positioned within the first channel and on the first projection, the first ledge extending towards the body;
a second projection extending from the body at the distal end, opposite the first projection, and including a second through-bore, wherein the second projection forms a second channel with the body; and
a second ledge positioned within the second channel and on the second projection, the second ledge extending towards the body; and
a second portion, comprising:
a support body connected to the body, and extending between a first end and a second end;
a round body extending from the support body;
a first locking tab positioned on the first end of the support body, extending from the support body, and including a first ledge; and
a second locking tab positioned on the second end of the support body, opposite the hollow body, extending from the support body, and including a second ledge.

23. The device of claim 22, wherein the support body is arranged at the proximal end of the body.

24. The device of claim 22, wherein the support body includes a sealing surface arranged on an opposite side of the support body than the body.

25. (canceled)
